(19) United States
(12) Patent Application Publication
(10) Pub. No.: US 2024/0163688 A1
(43) Pub. Date: May 16, 2024

(54) BEAM MANAGEMENT AND BANDWIDTH PART OPERATION FOR NON-TERRESTRIAL NETWORKS

(71) Applicant: INTERDIGITAL PATENT HOLDINGS, INC., Wilmington, DE (US)

(72) Inventors: Allan TSAI, Boonton, NJ (US); Patrick SVEDMAN, Stockholm (SE); Pascal ADJAKPLE, Great Neck, NY (US); Kyle PAN, Saint James, NY (US); Guoding ZHANG, Woodbury, NY (US); Yifan LI, Conshohocken, PA (US); Jerome VOGEDES, Milwaukee, WI (US)

(21) Appl. No.: 18/553,866

(22) PCT Filed: Apr. 5, 2022
(86) PCT No.: PCT/US2022/071546

§ 371 Date: Oct. 4, 2023

Related U.S. Application Data
(60) Provisional application No. 63/170,968, filed on Apr. 5, 2021.
(60) Provisional application No. 63/203,968, filed on Aug. 5, 2021.

(51) Int. Cl. H04W 16/28; H04W 72/0457; H04W 72/232; H04W 76/20; H04W 80/02; H04W 84/06

(52) U.S. Cl. CPC H04W 16/28; H04W 72/0457; H04W 72/232; H04W 76/20; H04W 80/02; H04W 84/06

(57) ABSTRACT

Methods, apparatus, and systems for beam management and BWP operations for NR NTN. Beam management methods for both one beam per cell and for multiple beams per cell may be implemented. A transmission configuration indication (TCI) state sequence also may be implemented, in which a network node may broadcast the transmission of TCI states.

### CROSS-REFERENCE TO RELATED APPLICATIONS

This application claims the benefit of U.S. Provisional Patent Application No. 63/203,968, filed on Aug. 5, 2021, entitled “Beam Management and Bandwidth Part Operation for Non-Terrestrial Networks,” and of U.S. Provisional Patent Application No. 63/170,968, filed on Apr. 5, 2021, entitled “Beam Management And Bandwidth Part Operation For Non-Terrestrial Networks,” the contents of which are hereby incorporated by reference herein.

### BACKGROUND

The 3rd Generation Partnership Project (3GPP) has begun working on the standardization of next generation cellular technology, called New Radio (NR), which is also referred to as “5G”. 3GPP has identified a variety of use cases that NR is expected to support, resulting in a wide variety of user experience requirements for data rate, latency, and mobility. One area in which improvements are needed relates to beam management and bandwidth part operations (BWP) for NR non-terrestrial networks (NTNs).

### SUMMARY

Described herein are methods, apparatus, and systems for beam management and BWP operations for NR NTN.

Beam management methods are described for both one beam per cell and for multiple beams per cell. A transmission configuration indication (TCI) state sequence is also disclosed in which the network/gNB may broadcast the transmission of TCI state(s). A beam failure detection method for NR NTN is also disclosed.

BWP operations for NR NTN are also disclosed, including BWP switching via group common PDCCH (GC-PDCCH), increasing number of BWPs for NR NTN, and simultaneous TCI sates update/indication when BWP switching.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to features that solve any or all disadvantages noted in any part of this disclosure.

### BRIEF DESCRIPTION OF THE DRAWINGS

The following detailed description is better understood when read in conjunction with the appended drawings. In the drawings:

FIG. 1A illustrates an example earth fixed cell scenario;

FIG. 1B illustrates an example carth moving cell scenario;

FIG. 2A illustrates example PCI mappings with spot-beam options in NR NTN-Option-a Multi-beam/SSB per Cell;

FIG. 2B illustrates example PCI mappings with spot-beam options in NR NTN-Option-b Single-beam/SSB per Cell;

FIG. 3A illustrates an example option for spot-beam layout with BWP;

FIG. 3B illustrates another example option for spot-beam layout with BWP;

FIG. 4 illustrates an example method;

FIG. 5 illustrates an example measurement RS;

FIG. 6 illustrates an example of an increased number of BWP for NR NTN to support BWP adaption;

FIG. 7A illustrates two circular polarizations same beam layout;

FIG. 7B illustrates two circular polarizations for different beam layout;

FIG. 8A illustrates polarizations for SSB TDM;

FIG. 8B illustrates polarizations for SSB PDM;

FIG. 9 illustrates an exemplary method for beam management and bandwidth part operation for NTNs;

FIG. 10A illustrates an example communications system;

FIG. 10B illustrates an exemplary system that includes RANs and core networks:

FIG. 10C illustrates an exemplary system that includes RANs and core networks;

FIG. 10D illustrates an exemplary system that includes RANs and core networks;

FIG. 10E illustrates another example communications system:

FIG. 10F is a block diagram of an example apparatus or device, such as a WTRU; and

FIG. 10G is a block diagram of an exemplary computing system.

### DETAILED DESCRIPTION

### Beam Management in NR Rel-15 and -16

Beam management may be categorized as three parts in NR: 1) Initial beam establishment: 2) Beam adjustment, primarily to compensate for movements, blockage and rotations of the mobile device, but also for gradual changes in the environment: or 3) Beam recovery to handle the situation when rapid changes in the environment occur.

Three phases of DL beam management may be used with beam sweeping on TRP and/or UE side as described below:

Phase 1—Beam selection: the gNB or TRP sweeps beams and UE selects one or more best beams and reports its selection to gNB. The UE selects a better beam (or set of beams) to set up a directional (and fully beamformed) communication link. In the initial access, UE may perform beam pairing by creating mappings between SSB and PRACH.

Phase 2—Beam refinement for transmitter (gNB or TRP Tx): the gNB or TRP may refine beam (e.g. sweeping narrower beams over narrower range or localized region compared to phase 1) and the UE detects one or more best beams and reports them to gNB or TRP (note: in a serving cell, a gNB may have multiple TRPs). In RRC connected state, CSI-RS may be configured with or without repetition. In case of repletion not being enabled, UE can select and report one or more finer beams.

Phase 3—Beam refinement for receiver (UE Rx): the gNB fixes a transmit beam (transmit the same beam repeatedly) and the UE refines its receiver beam. The UE sets the spatial filter on receiver antenna array. This may be used for example for UEs with analog or hybrid beamforming implementations that need to perform beam sweeping in time to find the best receiver beam. In RRC connected state, CSI-RS may be configured with repetition, thus it may be assumed that UE can determine one or more finer beams accordingly.

In NR, the evaluation of the quality of the received beam could be based on different metrics such as RSRP, RSRQ and SINR.

### Quasi-CoLocation in NR Rel-15 and -16

In NR, Quasi-CoLocation (QCL) information may be used to support reception and channel estimation of both PDSCH and PDCCH at UE. In both cases, the gNB can indicate the antenna port used by a specific SS/PBCH block (SSB) is QCLed with the antenna port i.e., DM-RS port used by the PDSCH and PDCCH. Also, gNB can indicate that the antenna port used by specific CSI-RS is QCLed with the antenna port (i.e. DM-RS) used by PDSCH or PDCCH transmission.

gNB uses a combination of RRC signalling, MAC-CE signalling and PDCCH to indicate UE about which SSB and/or CSI-RS are QCL with PDSCH and PDCCH. The QCL indication for PDCCH and PDSCH in NR Rel-15 and -16 are summarized as follows:

Steps for PDSCH QCL may include the following. At step 1, gNB sends RRC signalling to configure Transmission Configuration Indicator (TCI) for the PDSCH QCL. At step 2, send MAC-CE to activate a subset of TCI states. MAC-CE can activate up to 8 TCI states, mapped to up to 8 TCI codepoints. At step 3, send DCI indicating one TCI state as well as PDSCH resource allocation. At step 4. UE decodes PDSCH using QCL information provided by TCI state.

Steps for PDCCH QCL may include the following. At step 1, gNB sends RRC signalling to configure TCI for the PDCCH QCL. At step 2. send MAC-CE to activate the TCI state. MAC-CE may be used to activate one TCI state for a specific CORESET. At step 3. UE decodes PDCCH using QCL information provided by TCI states.

### Multiple Transmission/Reception (M-TRP) in Rel-16

In NR Rel-16, enhanced MIMO includes support of multiple transmit receive point (M-TRP) transmission. In M-TRP transmission scheme, data may be transmitted to or received from multiple TRPs for diversity to improve transmission and reception reliability and robustness. For data scheduling via M-TRP, support for both single DCI and multiple DCIs for ideal backhaul and non-ideal backhaul are introduced in Rel-16, respectively. In single DCI based scheme, a DCI schedules PDSCH from multiple (e.g., two) TRPs, e.g., one set of PDSCH layers from a first TRP and a second set of PDSCH layers from a second TRP. In multiple DCI based scheme, two TRPs can independently schedule PDSCHs from two TRPs.

### Bandwidth Part (BWP) Operations in NR

In NR, A BWP is a contiguous BW partition on a carrier in a serving cell that uses some given numerology/SCS. Each BWP consists of a group of contiguous physical resource blocks (PRB) that are configured by a gNB to a UE. According to current NR specification, up to four DL BWPs and four UL BWPs may be configured to a UE on a serving cell. The number of activated BWP is constraint by one DL and one UL BWP at a given time in one activated serving cell. In addition, UE is not expected to receive or transmit signals outside the active BWP, except for inter-frequency measurement gaps configured by the network.

BWP switching is a procedure that simultaneously activate an inactive BWP (e.g., dedicated BWP) while deactivate an active BWP (e.g., from default or initial BWP). BWP switching may be triggered via DCI, Radio Resource Control (RRC) signaling, BWP inactivity timer, or by MAC entity upon initiation of random access (RA) procedure. Switching the BWPs using DCI allows activating pre-configured BWPs, which enables faster switching. Switching back to the default BWP may be based on the expiry of bwp-InactivityTimer. The default values of bwp-Inactivity Timer are within the range of 2-150 ms.

NR has defined the BWP switch delay requirement. BWP switch delay is the time during which the UE is required to complete the switch from the original BWP to the new activated BWP. During BWP switch time the UE is not required to transmit UL signals or receive DL signals on the cell while BWP is switched. The starting time of BWP switch delay for DCI-based BWP switch is the slot where the UE receives BWP switching request. For timer-based BWP switch, the starting time of BWP switching is the slot at the beginning of a subframe (for FR1) or half-subframe (for FR2) immediately after bwp-Inactivity Timer expires. For RRC-based BWP switch, the starting time of BWP switching is the last slot containing the RRC command including BWP switch request.

### (Spot-)Beam Switching and Cell Mapping in NTN

In NTN, each LEO satellite may generate multiple spot beams to serve UE on the ground. Dependent on satellite's antenna type and configuration, the satellite spot beam coverage area may be determined. In general, the radius of a LEO satellite spot beam could be ranged from several km (e.g., 20 km) to thousand km.

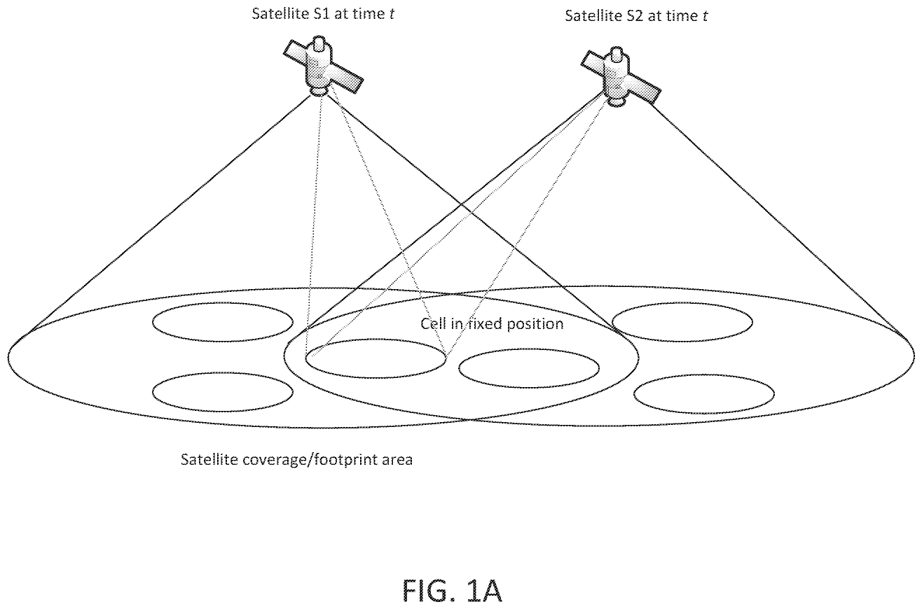

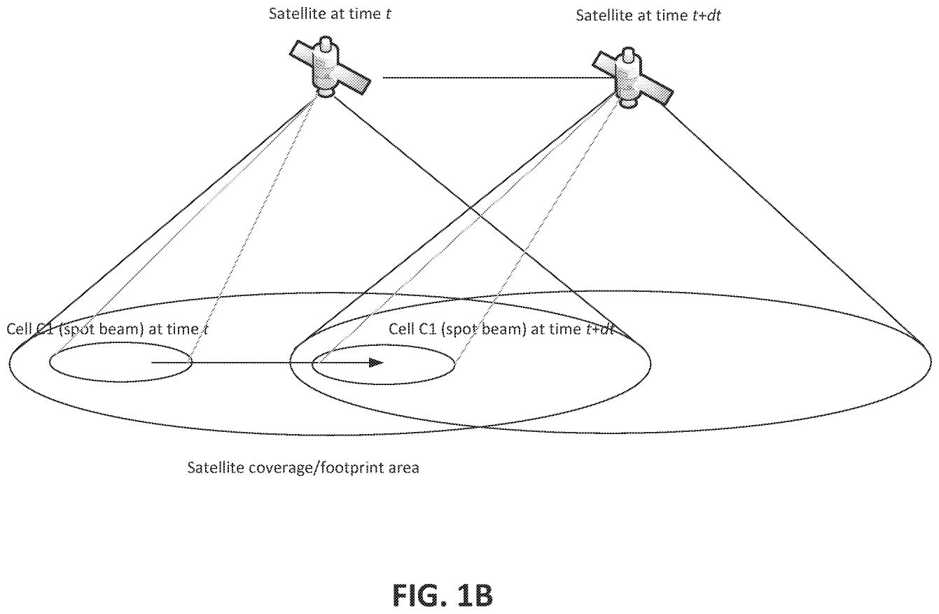

In NR NTN, it supports two deployment scenarios for the satellite cells. i.e. carth fixed cell and earth moving cell. For the earth fixed cell deployment, earth fixed cells assume that the cells are fixated to a certain location on Earth from the time where the satellite (these cells belong to), is at a certain elevation angle over the horizon until the same satellite has reached the same elevation angle at the opposite horizon (e.g., LEO/MEO with steerable beams). The Earth fixed cell deployment is shown in FIG. 1A. On the other hand, for the earth moving beam deployment, the serving spot beam will change from time to time and assume that the cells follow the satellite coverage. The Earth moving deployment is shown in FIG. 1B.

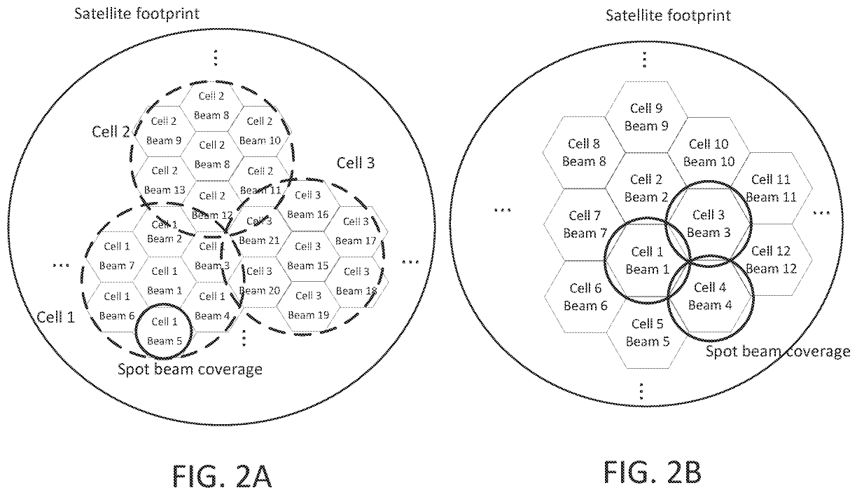

There are two options for mapping of primary cell index (PCI) and SSB to satellite spot beam in NR NTN. In an Option-a, multiple satellite spot beams per PCI with SSB as shown in FIG. 2A. In an Option-b, one satellite spot beam per PCI FIG. 2B.

### Frequency Reuse Factor and Co-Channel Interference in NTN

In NTN communication, frequency reuse factor (FRF) greater than one may be considered for reducing co-channel spot-beam interference. There are two possible Frequency reuse factors (FRF)=1 or >1 in NTN deployment, let N_{c} denote the number of spot beam within a cell.

In Case 1: N_{c}=FRF: In this case, beam and frequency band can have one-to-one mapping within a satellite footprint. No co-channel interference (beam interference) occurs within a satellite footprint.

In Case 2: N_{c}>FRF: In this case, multi-beam may be mapped to a same frequency band. Multiple co-channel beams transmitted by the same satellite occur in a same frequency band.

Polarization is another tool to reduce co-channel beam interference in NTN. Antennas may be designed to receive or transmit a wave of given polarization with respect to the direction of propagation (right-hand/clockwise or left-hand/counter-clockwise) while isolating the orthogonal polarization. Therefore, two links without co-channel interference may be established concurrently at the same frequency. Therefore, polarization-division multiplexing (PDM) may be adopted and combined with frequency reuse factor (FRF) for further mitigation of co-channel beam interference in NTN.

### Beam Layout with BWP in NR NTN

In NR NTN, there may be two options for satellite spot-beam layout with BWP. In an Option-1, there may be a same beam layout for BWP#0 and BWP#x. In an Option-2. there may be a hierarchical beam layout for BWP#0 and BWP#x.

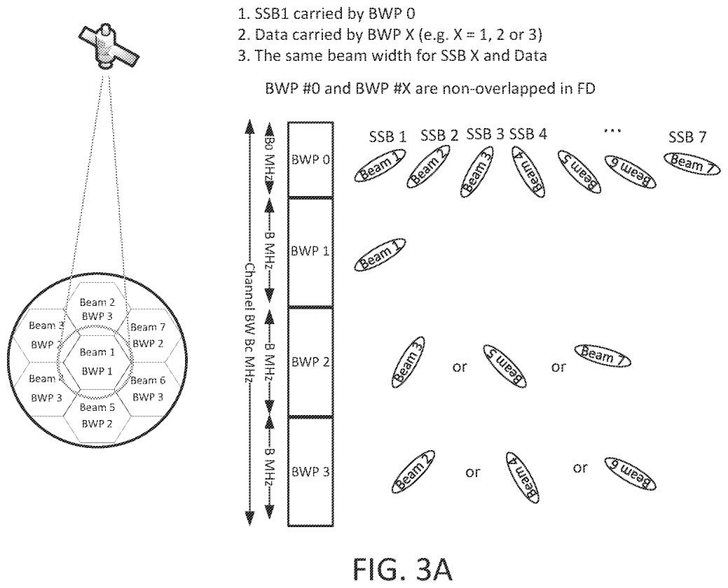

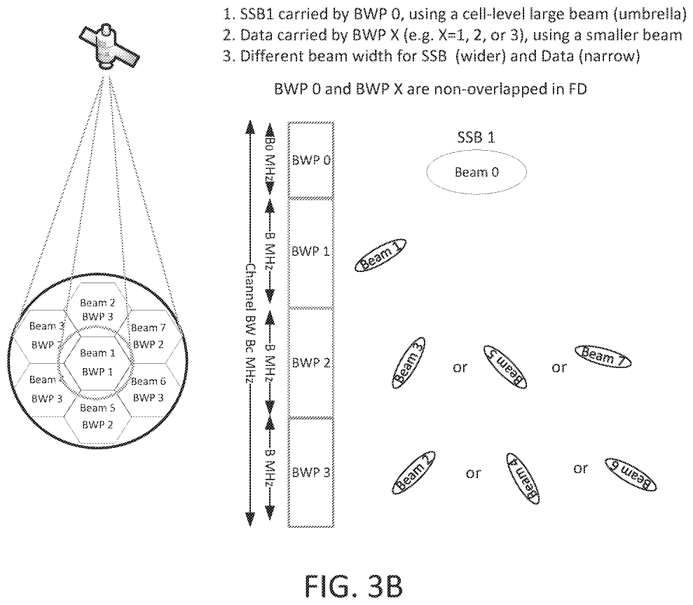

In Option-1, network uses BWP #0 and one BWP #x (e.g. x=1, 2 or 3) on a same beam for both control (PDCCH) and data (PDSCH) reception. Transmissions in BWP#0 across different beams of the cell may be time multiplexed (TDM). One design example is shown in FIG. 3A, assuming the network use FRF=3 for mitigation co-channel beam interference and configure BWP #1. #2 and #3 are used for frequency reuse. Also, as shown in FIGS. 3A and 3B, an NTN network assumes multi-beam (e.g. 7 beams) per cell and each beam has the same beamwidth. For option-2 as shown in FIG. 3B, BWP#0 use a cell-specific anchor beam covering the whole cell footprint, enabling initial access and broadcast transmission including SSB. SIBI, etc. For UEs in RRC connected state, satellite DL transmission and satellite UL reception may be performed using multiple smaller spotbeams, each associated with a non-zero BWP #x for the transmission of dedicated signals and channels.

Issues addressed in more detail herein may include beam management for NR NTN or bandwidth part (BWP) operations for NR NTN.

### Beam Management for NR NTN

In conventional NR specification, beam management (BM) needs to consider two beam layout options, first option is one beam per cell, the other is multi-beam per cell.

In addition. NR BM may rely on the periodic RS (CSI-RS) for beam/TCI state reporting and reselection. Dependent on the velocity of the satellite and the height of the satellite (e.g., LEO, MEO, etc.), the satellite's spot beam switch or reselection may occur predictably: this may make the periodical CSI-RS (P-CSI-RS) report ineffective for some deployment scenarios. For example, the spot beam switching may be predictable (e.g., the satellite moves along a fixed orbit) in NTN. The longer round-trip time (RTT) may affect the outdated CSI reporting. Considering the issues described above, a more efficient BM and BFD procedure designed to account for satellite's spot beam switching and to fit CSI measurement and reporting latency into the satellite's spot beam switching time window may be considered.

In NR, the UE 201 is not expected to receive or transmit signals outside the active BWP, except for inter-frequency measurement gaps configured by the network. However, for FRF>I in NR NTN, and in departure from legacy NR design wherein only one BWP is active at a time, more than one BWPs may be simultaneous active, with at least different active BWPs associated with different beams within the same PCI. In this case, the UE 201 may be required to support more than one active BWPs, or the UE 201 may be required to support intra-cell-inter-BWP measurement, in which either is generally not supported in legacy NR. Furthermore, support for such use cases may lead to data interruption, which is not desirable. Therefore, there should be support for intra-cell-inter-BWP CSI measurement with the need for CSI-RS reporting for beam layout options when thre frequency reuse factor is greater than one (i.e. FRF>1).

To address these problems, beam management methods are described herein for both one beam per cell and for multiple beams per cell. A transmission configuration indication (TCI) state sequence is also disclosed in which the network/gNB may broadcast the transmission of TCI state(s). A beam failure detection method for NR NTN is also disclosed.

NR NTN have considered supporting two beam layout options. The first option is one beam per cell and the second option is option is multiple spot-beam per cell as shown in FIG. 2A and FIG. 2B respectively. Described herein are methods, systems, or apparatus that may address the issued described above and throughout based on one beam per cell (e.g., option-b) or multiple beams per cell (e.g., Option-a) as shown in FIG. 2A and FIG. 2B respectively.

### BM for One Beam Per Cell

For one (spot) beam for a cell as shown in FIG. 2B, one SSB (or a primary cell index (PCI)) per cell is sufficient. Here, there may be an assumption that there is no sub-beam (e.g., spatial direction beam) associated with the main (spot) beam except polarization scheme. BM may be simplified in this case because there may be no need to distinguish the data and control beam and only single beam per cell. Also, each spot beam radius may be with several km (e.g., 10 to 25 km) for Low Earth Orbit (LEO) and its traveling speed which is dependent on the height may be ranged from few km/sec (e.g., LEO with height 600 km, its traveling speed is 7.6 km/sec). When one beam per cell case, the handover frequency may be quite intensive. For example, for a LEO with height 600 km and beam's radius 10 km, the handover frequency may be less than 3 sec. In legacy NR, it requires RRC reconfiguration. However, considering Jong RTT time in NTN. RRC reconfiguration may take much latency for this one beam per cell case. In addition, a group of UEs need to perform handover simultaneously and this may burden the network loading. Therefore, we propose the following methods to minimum latency and reduce network traffic.

The QCL information indication for PDCCH and PDSCH in NR specification may be simplified as follows. Firstly, PDSCH and PDCCH may share the same QCL information. This scheme is like beam operation which refers to PDCCH and PDSCH using the same beam. Secondly, UE 201 may assume PDCCH and PDSCH TCI state QCL (e.g., at least Type-D) with the SSB transmitted in the cell because single spot beam is applied per cell. In addition, RRC TCI state configuration may be applied for CORESET(s) in a same BWP.

For example, consider a LEO satellite system with an orbit height of 600 km. the travelling speed of the satellite may be about 7.6 km/s. If a cell coverage (or cell footprint) is assumed around 15 km (cell radius) then the satellite spot beam switching may may occur around every four second. Although BM in one beam per cell case may be simplified, too frequent cell handover may cause some unnecessary signaling overhead for BM. Furthermore, the UE 201 (e.g., WTRU 102a) may suffer from frequent handover, which may cause interrupted communication. BM methods for one beam per cell scenario are disclosed herein.

After a UE 201 enters RRC connected mode (RRC_CONNECTED state), the network (e.g., base station 202 or another network node) may configure the UE 201 with a set of TCI state information (e.g., neighbor cell's or non-serving SSB), CSI-RS resource set configuration or BWP configuration, etc. One case is that UE 201 may receive non-serving cell configuration including TCI states. Another case is that the serving cell configuration including TCI states which includes non-serving sources RS. e.g., non-serving cell SSB. Although base station 202 is referred to herein, another network node is contemplated.

Base station 202 may not need to update the TCI configuration while UE 201 performs handover, thus signaling overhead and latency may be reduced. This may be because base station 202 only updates the TCI configuration for that configured neighbor cell's TCI state information has expired. Signaling overhead may be reduced because the new spot beam (a new TCI state) for the UE 201 is updated at handover. The satellite ephemeris data, beam switching time, and the sequence of satellite's spot beam for UE 201 may be known ahead of time. (Pre-) configuration of the TCI state information for UE 201 may reduce TCI signaling overhead due to beam switching when UE 201 is frequently handover.

When UE 201 performs handover. UE 201 may need to update TCI state (e.g., switching to an SSB/PCI which is not equal to serving cell) with signalling by the netwrok. The updated TCI states may signal via DCI or MAC-CE. The activation of TCI states via MAC-CE or DCI may be waved like legacy NR for single beam per cell. This is because only single beam is supported within a cell. Also, the defaulted TCI state (beam) may be equivalent to satellite spot beam.

Both PDCCH and PDSCH TCI state may be indicated by DCI or MAC-CE. For NR NTN, TCI indication via DCI may be preferred over using MAC-CE. This considers longer RTT time in NTN. If TCI indication is via DCI, then it may be based on UE specific DCI format 1_1/1_2 or by a group-common DCI (GC-PDCCH). TCI indication via a group common DCI (e.g., DCI format 2_x) may also be desirable for NR NTN. This may be because satellite spot beam switching (e.g., due to satellite moving) may impact some of UEs 201 under the coverage. Therefore, TCI indication for PDCCH and PDSCH use group common DCI format (e.g., format 2_x) may be preferred. UE 201 may decode PDCCH or PDSCH using QCL information provided by the TCI state from DCI. If TCI state indication is not from DCI format 1_1/1_2 then the TCI field in DCI format 1_1/1_2 may be ignored or may be used for other purposes. Another way to address issues is the TCI field in NR DCI format 1_1/1_2 may be trimmed for DCI format 1_1/1_2 DCI size reduction in NR NTN.

For frequency reuse factor (FRF) is greater than 1 scenario in NTN, if the indicated TCI state (e.g., indicated by DCI or MAC-CE) is different than the current TCI state then UE 201 may simultaneously perform BWP switching. The activated BWP may be signalling by UE specific DCI (e.g., DCI format 1_1/1_2) or group-common (e.g., DCI format 2_x). If group-common DCI is used for TCI state indication, UE 201 may ACK for successful received group-common DCI. The TCI update may take effect after a time-offset after UE 201 acknowledges.

The network may activate a TCI state for channel(s) (e.g., CORESET) in inactivated or activated BWP for one or more UE(s) 201. In this way, UE 201 may switch to an activated BWP and a different satellite spot beam. For the case of TCI activation for multiple UEs, the network may use group common signaling (e.g., group common DCI or group common MAC-CE). Here, group common MAC-CE may refer to MAC-CE multiplexed in multicast shared channel. e.g., PDSCH or PUSCH.

CSI-RS resource set may be configured at an activated BWP which is not the same BWP for data reception. The non-zero power CSI-RS (NZP-CSI-RS) resources in a configured CSI-RS resource set may be associated with the current serving cell TCI state or non-serving cell TCI state (e.g., neighbor cell SSB) or non-serving cell SSB may be transmitted at an activated BWP. For example, when FRF>1, UE 201 may perform intra-frequency measurement without switching to other BWP.

Intra frequency measurement (e.g., cell selection/reselection) report may be used for beam switching.

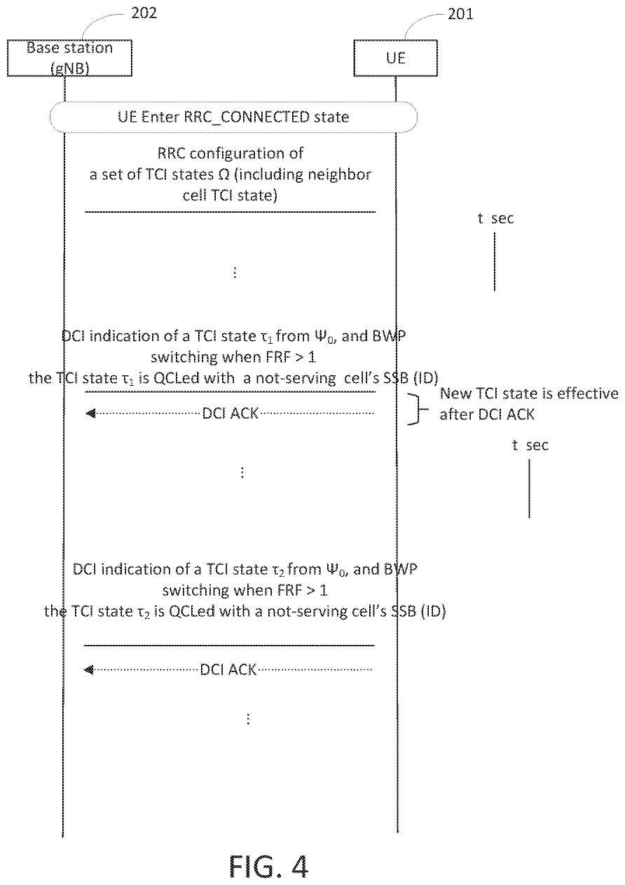

One example BM method (e.g., use DCI for TCI states and BWP switching) for one beam per cell in NR NTN is shown in FIG. 4. BM for multi-beam per cell

For multiple spot-beams for a cell as shown in FIG. 2B, most of NR BM methods may be reused. However, since a satellite is moving along a given orbit, proper configuration of TCI states may be disclosed to reduce BM effort like reducing number of instances for CSI reporting, and latency associated with each instance of BM. The following enhancement BM methods for multibeam per cell scenario are disclosed.

Network may map cach spot beam with a TCI state within a cell. RRC may configure UE 201 with TCI state configuration as Rel-15/-16. The cell's TCI state may be activated via MAC-CE. To shorten the latency, a group common DCI may be used for TCI state activation for a group of UE(s) 201. In addition, the TCI state may be pre-configurated with ephemeris data of the satellite so the UE 201 knows based on the position of the satellite in space and time information, thus, UE 201 may know which TCI state to use for CSI measurement.

In NTN, longer RTT is expected, MAC-CE activation may have longer latency than that in typical Terrestrial networks. Methods to reduce the TCI state activation efforts, which may reduce latency, are disclosed, such as: 1) Time-based TCI States, 2) Space information for the prediction of TCI state, or 3) TCI state sequence.

For frequency reuse factor (FRF) is greater than 1 scenario in NTN, if the indicated TCI state (e.g., indicated by DCI or MAC-CE) is different from the current TCI state then UE 201 simultaneously performs BWP switching. The activated BWP may be signaling by UE specific DCI (e.g., DCI format 1_1/1_2) or the group-common DCI (c.g., DCI format 2_x).

The network may activate a TCI state for channel(s) (e.g., CORESET) in inactivated or activated BWP for one or more UE(s). In this way. UE may switch to an activated BWP and a different satellite spot beam. For the case of TCI activation for multiple UEs, the network may use group common signaling (e.g., group common DCI or group common MAC-CE). Here, group common MAC-CE refers to MAC-CE multiplexed in multicast shared channel, e.g., multicast PDSCH or PUSCH.

CSI-RS resource set may be configured at an activated BWP which is not the same BWP for data reception. The non-zero power CSI-RS (NZP-CSI-RS) resources in a configured CSI-RS resource set may be associated with the current serving cell TCI state or non-serving cell TCI state (e.g., neighbor cell SSB) or non-serving cell SSB may be transmitted at an activated BWP. For example, when FRF>1. UE may perform intra-frequency measurement without switching to other BWP.

### Time-Based TCI States

The serving satellite may broadcast its ephemeris to the NTN UE and the satellite 203 is moving on a known orbit. If the UE 201 knows the time information associated with activated TCI state(s) note: the time information may vary with NTN type like LEO, MEO etc., then the UE 201 may estimate (e.g., predict) the beam pattern transmitted at a specific time. In this way, CSI measurement may be conducted more efficiently, and the received beam may be formed without a TCI indication procedure. As disclosed, the time-based TCI states may be based on explicit time-based TCI state or implicit time-based TCI state.

The network may configure a set of TCI states and each TCI state may be associated with an explicit time value or a timer. For example, RRC may configure for a UE 201 or a group of UEs 201 for TCI state associated with a time value or timer information and MAC-CE may perform the update for TCI state with the time value or timer. The time tag may be treated as the time when UE 201 expects to update the TCI state. For example, the network may setup or enable the CSI-RS reporting by a time-window (e.g., t ms) for the expiring TCI state(s). UE 201 may predict the received spatial information in advance, thus. UE 201 may avoid performing blindly RX beam sweeping. In addition, UE 201 may avoid unnecessary CSI monitoring because network may know when the current TCI state will be expiry for a UE 201 or a group of UEs 201.

### Space Information for the Predication of TCI States

Unlike the disclosed methods for time-based TCI states, the time-based TCI states use time information for prediction of beam switching. Instead, UE 201 may be based on the broadcast satellite ephemeris, spot-beam radius or its global position (if available) to predict or estimate when the TCI is required for update. In addition, UE 201 may assist the network for updating the TCI state through many means like UE position (if available) or elevation angle, etc. For example, UE 201 may estimate the time when the current TCI state is going to expire and feedback or request for the update of TCI state. Note, the format for feedback may be based on (1) the UE position/location. (2) the angle (e.g., elevation angle, angle of arrival AOA) information, or (3) the request (e.g., 1 bit) for TCI state update. The feedback may use a scheduling request (SR), a configured grant (CG), contention free PRACH, or contention-based PRACH for requesting a TCI state update. In addition, the hybrid of time-based TCI method may hybrid assist with space information for better TCI state prediction.

### TCI State Sequence

The network may predict the starting TCI state and the last TCI state, and the period of each TCI for a TCI state sequence served by the cell for a UE 201 or a group of UEs 201. For example, for earth moving cell scenario as shown in FIG. 1B, the satellite 203 may predict which spot beam(s) and the time duration for a group of UEs 201. If the UE 201 knows that the order of the activated TCI state sequence which is arranged from a starting TCI state to a last TCI state and the TCI state (periodically) changed rate, then BM may be simplified because the UE 201 may estimate the beam pattern and predict the TCI state when will be updated. Furthermore, the step of the activation of TCI states in NR may be removed thus it may reduce the signalling overhead and latency which may be preferred for NR NTN. The TCI state sequence may be configured via RRC when UE 201 is in RRC CONNECTED state and the TCI state sequence may be modified by MAC-CE. CSI reporting and Intra frequency measurement with FRF>1

In NR. BM CSI-RS resources in a CSI-RS resource set are transmitted in the same frequency (or at an activated BWP). In this way, the CSI-RS reporting for BM may be measured by UEs 201 only at the same BWP. Also, a legacy NR network needs to configure multiple CSI-RS resources associated with other TCI states at an activated BWP for UE 201 to perform CSI reporting. This approach may allow UE 201 to perform CSI reporting without frequency retuning, but there are some CSI-RS resource configuration constraints such as the following. With reference to a first constraint. CSI-RS resource(s) associated with other TCI states (e.g., at least not the same QCL Type-D TCI state) needs to be based on TDM (also consider UE 201 may be only capable to receive a single beam at a time) for avoiding co-channel interference. With reference to a second constraint, for those CSI-RS resources being associated with other TCI states (e.g., QCL Type-D TCI states), DL data may not be multiplexed with the CSI-RS resource associated with other TCI states.

If the measurement reference signal (RS) for the other beams is in different BWPs. the beam management conducts in different BWP. It should be noted that this scenario may be common in case of FRF>1. Furthermore, the configured BWPs do not include the frequency domain resources of the SSB associated to a specific BWP (e.g., BWP #0 or an initial BWP). In this case, the CSI reporting and the intra-frequency measurement is performed outside of the activated BWP for a UE 201 because it may require to perform BWP switching back and forth just even for intra-frequency measurement. Therefore, the following methods are considered for this case. For a first method, CSI measurement may be supported outside of an activated BWP, e.g., in inactive BWP.

For a second method, intra frequency measurement may be supported outside of an activated BWP, e.g., in inactive BWP for NR NTN. The measurement gap lengths (e.g., y ms) with measurement gap repetition periodicities (e.g., x ms) may be configured by RRC. Also, the time for performing the measurement gap may also be associated with time-based TCI state instead of using periodical configuration.

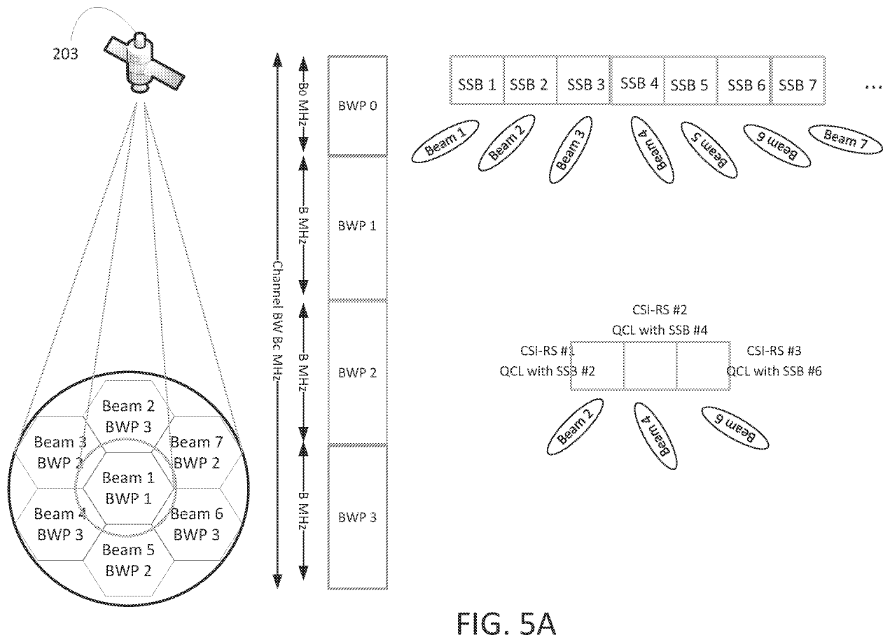

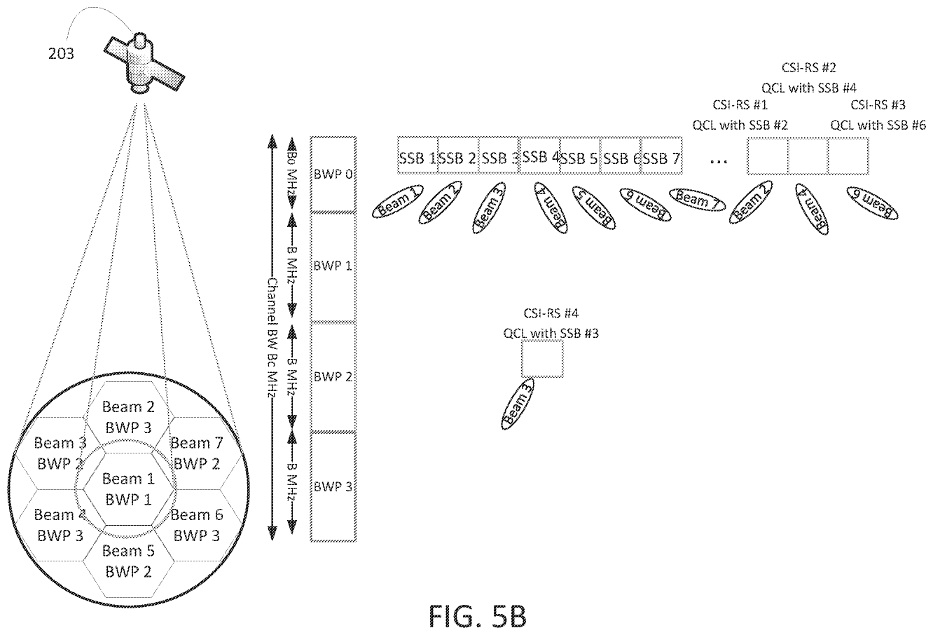

For an example for NTN with FRF>1 as shown in FIG. 5A-FIG. 5B, the measurement RS (e.g. CSI-RS, SSB) for other beams is in the activate BWP in FIG. 5A and different BWPs in FIG. 5B. In FIG. 5A-FIG. SB, there may be 7 spot beams within a cell and 7 SSB(s) may be associated with cach spot beam. In this example. UE 201 may be configured with four BWP (e.g., BWP #0, BWP #1, BWP #2 and BWP #3 and FRF=3). Therefore, the spot beam #3, #5, or #7 may be the serving beam for BWP #2 and spot beam #2, #4, or #6 may be the serving beam for BWP #3 and spot beam #1 may be the serving beam for BWP #1. If a UE 201 is with spot beam #3 as the serving beam, then UE 201 is using BWP #2. If measurement RS may be with the same activated BWP (e.g., BWP #2), then CSI-RS resources for other spot beam (e.g., #3, #5, or #7) reception needs to be configured within the activated BWP (e.g., BWP #2). Another case is other RSs (e.g., spot beam #3, #5, and #7) may be transmitted at a specific BWP (e.g., BWP #0). In this case, UE 201 may be allowed for performing the measurement outside of the activated BWP (e.g., BWP #2) to reduce the signaling BWP switching overhead for measurement. Beam failure detection (BFD)

In NR Rel-15/16, BFD procedure is based on a periodical CSI-RS. An NR TN gNB may transmit multi-beams (e.g., multiple TCI states) CSI-RS as selected beam candidates. However, for NTN, each satellite 203 bas its own specific orbit (or path) Therefore, it is difficult to configure or simultaneously transmit the periodical CSI-RS with multiple spot beams (TCI states) with same beam pattem (e.g., beam width) unless the UE 201 is at a spot beam boundary within a cell. The other spot beams configured as the beam candidates may be from other satellite 203 while UE 201 is not in a spot beam boundary. The disclosed subject may enhance the BFD procedure.

The BFD procedure may include, the candidate beam may be based on multiple periodical CSI-RS for (e.g. candidateBeamRSList), cach periodical CSI-RS may only include a single CSI-RS resource with its TCI state being associated with a non-serving TCI state. The CSI-RS resource for failureDetectionResources may be default with the serving TCI state.

The BFD procedure may include Aperiodic CSI-RS (AP-CSI-RS) resource may be used for the beam candidate selection in BFD (e.g. candidate BeamRSList and failure DetectionResources).

The BFD procedure may include if TCI state is associated with time-space-based information and no periodical CSI-RS resources are configured for UE to perform BFD, then UE 201 may use/assume using SSB in a common BWP (e.g. BWP #0) as the candidates for beam selection in BFD. In addition, if a UE is configured with a (intra-frequency) measurement gap and the serving TCI state is going to be expired, then UE 201 may also use/assume using SSB in a common BWP (e.g. BWP #0) as the candidates for beam selection in BFD.

The BFD procedure may include if the DCI with serving TCI state and its hypothetical BLER exceed a threshold, then UE 201 may trigger the beam failure recovery (BFR) and request the beam recovery based on a selected spot beam candidate.

In the beam failure recovery procedure of NR, the UE 201 first transmit PRACH or PUCCH, and then monitors PDCCH the network update the beam/TCI state after a certain period. To account for the longer RTT in NIN, a UE 201 may stop monitoring DCI and data reception for a time period (e.g. the time period can be set to RTT). In this way, the power consumption may be reduced for NTN UE. For example, the time offset, or the timer may be used for indication. The value for this time period or timer may be configured based on the RTT, note the RTT may also depend ont the satellite deployment (e.g., LEO, MEO, etc.). UE 201 starts to monitor the beam failure response after a time offset or an expiry of the corresponding timer.

### Bandwidth part (BWP) Operations for NR NTN

In NTN communication systems, multi-beam transmission techniques have been widely adopted to increase transmission data rates. Furthermore, a frequency reuse (FR) scheme where adjacent beams are allocated with non-overlapping frequency spectrum (or different polarizations) is adopted to mitigate the co-channel inter-beam interference. In NTN FRF>1 FDD scenario, beam switching may result in a BWP (frequency band) switching in both DL and UL. However, simultaneous BWP switching for DL and UL is not supported in legacy NR specification.

In NR, a target TCI state (e.g. PDCCH DM-RS, PDSCH DM-RS, CSI-RS. etc.) is quasi co-located (QCLed) with a DL reference signal (e.g., SSB or CSI-RS). However, a satellite spot beam switch does not mean spatial direction change from a UE point of view. For example, for earth moving cells scenario, the satellite spot beam switching may happen gradually with the movement of satellite as shown in FIG. 1A or FIG. 1B, but the spatial receiver parameter (e.g., dominant angle of arrival, etc.) from a UE 201 may not need to be adjusted when the UE 201 is assumed stationary for a certain period. In other words, satellite spot beam switching may not be equivalent to received spatial information change. However, satellite spot beam may be associated with a specific TCI.

In NTN FRF>1 FDD scenario, beam switching may result in a BWP (frequency band) switching in both DL and UL. Note: BWP switching for DL and UL simultaneously is not supported in NR specification. The BWP switching and TCI states are separately indicated in NR, which is not efficient for NR NTN when BWP and satellite spot beam switching need to be simultaneously switched or reselected. In addition, in FRF>1 scenario with more than one beam per PCI (Option-a in FIG. 2A), when a beam switching is triggered, UE 201 needs to perform BWP switching. Efficient method for NTN UE to support simultaneous satellite's spot beam (or a TCI state) and BWP switching, or reselection may be considered.

To address these problems, BWP operations for NR NTN are disclosed herein, including BWP switching via group common PDCCH (GC-PDCCH), increasing number of BWPs for NR NTN, and simultaneous TCI sates update/indication when BWP switching.

### BWP Switching via GC-PDCCH

In NTN with FRF>1, due to satellite moving, when a spot beam switching occurs, it may trigger a group of UEs with the same serving spot beam (i.e. serving TCI state) to perform BWP switching simultaneously. Therefore, group common DCI is suggested for the signaling a group of UEs when BWP switching is triggered due to spot beam switching. The group common DCI (e.g. format 2_x) may have the following properties. There may be a property for each UE ID field, up to maximum number of UEs in DCI format 2_x. There may be a property for each Target TCI state which is the TCI state for switching. The target TCI state may be shared by all UEs 201 or Target TCI state may be signalling for each UE 201. There may be a property for Target BWP ID which is the new activated BWP for switching. The target BWP ID may be shared by all UEs or BWP ID may be signalling for each UE. Increasing number of BWPs for NR NTN

According to current NR specification, up to four DL BWPs and four UL BWPs may be configured to UE 201 on a serving cell. In NR NTN with FRF>1. some configured BWP may be reserved for frequency reuse. In this way, the BWP adaption may be lost because some of BWP(s) are reserved for frequency reuse. Therefore, increased number of configured BWP for NTN UE may be considered to balance FRF and BWP adaption. However, the current NR DCI format 1_1/1_2 only reserves 2 bits for BWP indication. Therefore, disclosed are methods for increasing BWP indication, which may include number of bits in DCI format 1_1/1_2 TCI filed may be increased form 2 bits to M bits (e.g., M=3). The extract bits may be collected from reserved bits in DCI format 1_1/1_2 or reuse from another bit field. The size of DCI format 1_1/1 2 is not increased.

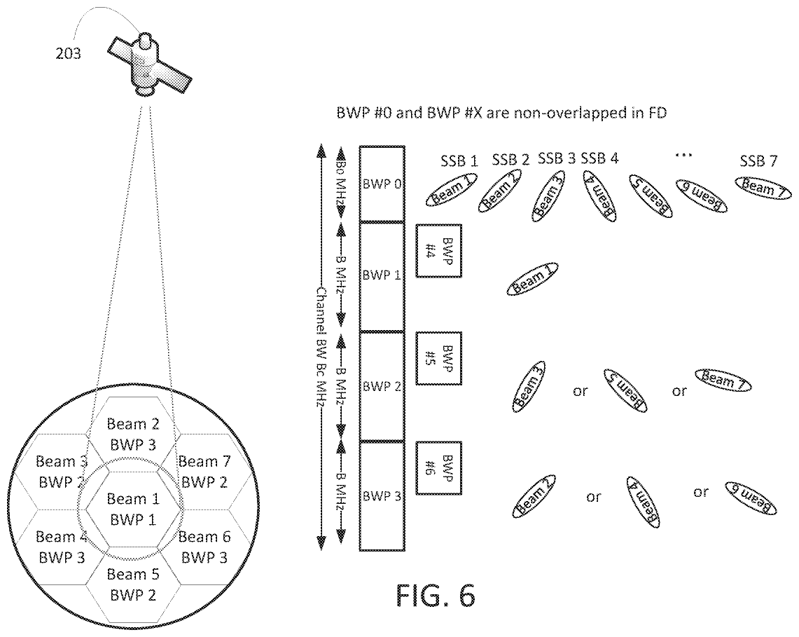

An example of increasing number of BWPs from 4 to 7 with FRF>1 is shown in FIG. 6. In FIG. 6, there are 7 spot beams within a cell and 7 SSB(s) are associated with each spot beam. In this example, UE 201 may be configured with 7 BWP. e.g., from BWP #0, BWP #1, . . . , BWP #7. Also, the FRF is set to 3. Therefore, the spot beam #3, #5 or #7 may be the serving beam for BWP #2 and spot beam #2, #4 or #6 may be the serving beam for BWP #3 and spot beam #1 may be the serving beam for BWP #1. If a UE 201 is with spot beam #3 as the serving beam, then UE 201 is using BWP #2. In addition, the following properties are disclosed.

There may be a property in which one BWP may be reserved with FRF=1 and all SSB may be transmitted in this BWP. For example, as shown in FIG. 6. BWP #0 is with FRF=1 and all RS (e.g. all SSB may be transmitted in this BWP #0).

There may be a property in which some of configured BWP may be reserved for frequency reuse. For example, as shown in FIG. 6, BWP #1, #2 and #3 are reserved for frequency reuse.

There may be a property in which some of configured BWP may be reserved for BWP adaption and those BWP used for BWP adaption may be within the BWP for frequency reuse. For example, as shown in FIG. 6. BWP #4, #5 and #6 are mainly used for BWP adaption within BWP #1, #2 and #3, respectively. In this way, if a UE 201 is in active BWP #2 then the UE 201 has two BWPs (e.g., BWP #2 and BWP #5) and there may be no need to perform physical BWP switching between BWP #2 and BWP #5 because the frequency band range of BWP #5 is withing BWP #2. In addition, some degree of BWP adaption property like NR may be preserved.

### Simultaneous TCI Sates Update/Indication When BWP Switching

When the spot beam switches then it may trigger the BWP switching at the same time in case of FRF>1. In addition, TCI ID and BWP ID has one-to-one mapping, e.g., via RRC configuration. For both unpaired and paired spectrum operation in NR NTN, a DL BWP from the set of configured DL BWPs with index provided by BWP-Id is linked with an UL BWP from the set of configured UL BWPs with index provided by BWP-Id when the DL BWP index and the UL BWP index are the same. For unpaired spectrum operation, a UE 201 does not expect to receive a configuration where the center frequency for a DL BWP is different than the center frequency for an UL BWP when the BWP-Id of the DL BWP is same as the BWP-Id of the UL BWP. In other words, for both unpaired and paired spectrum operation in NR NTN, DL, or UL BWP may be simultaneously switched.

UE 201 may assume the maximum switching delay time due to the spot beam and BWP switching at the same time may be determined by the following two parameters, i.e., the maximum switching delay time=max(timeDurationForQCL, BWPSwitchingDelay), where BWPSwitchingDelay denotes the BWP switching delay (e.g., the required time for switching to a new activate BWP)

When the spot beam switching triggers the BWP switching at the same time, but (e.g., DL or UL) HARQ buffer is not empty, UE 201 may keep the (current) HARQ buffer status while performing switching to the default or other active BWP. unless the following cases occur: 1) UE 201 reports out-of-sync; or 2) No PUCCH resource has been assigned at the default (UL) BWP.

In NR NTN with FRF>1, the configured TCI state cannot be applied to all configured BWPs. Therefore, simultaneous TCI state update for all BWP cannot be applied for NR NTN. Instead, in NTN, it may use different frequency ranges to different beams of a satellite 203 via the existing concept of bandwidth part (BWP) in NR. Therefore, the updated TCI states cannot be applied to all configured BWPs.

### Circular Polarization for NR NTN

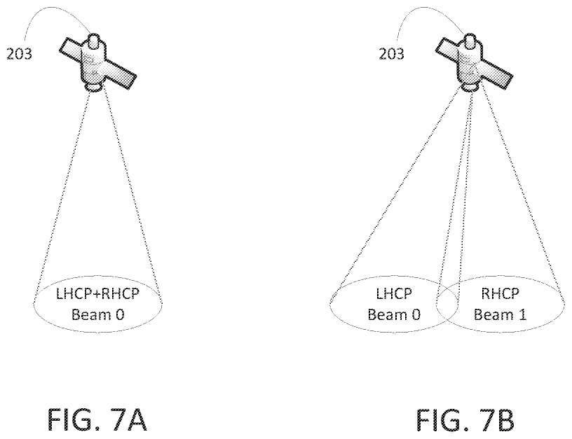

(Orthogonal) circular polarization array antenna is a popular antenna implementation for non-terrestrial networks/satellite communication. A circular polarization antenna may transmit and receive signals in up to two rotational polarizations and the rotation is referred to as Left- or Right-Hand Circular Polarization, (LHCP) or (RHCP), respectively. In practice, a circular polarization array antenna may be used with NTN multi-beams network for two possible use cases: the first use case is two circular polarizations with a same (spot-) beam layout as shown in FIG. 7A; thus it may enhance the system throughput. The second use case is two circular polarizations with different/inter (spot-) beam layout as shown in FIG. 7B; thus it may increase frequency reuse utilization, since Beam 0 and Beam 1 may use the same frequency with reduced inter-beam interference. To support the above use cases, the following polarization indication methods for beam management in NR NTN may be employed.

### Polarization Indication for Synchronization Block (SSB) in NR NTN

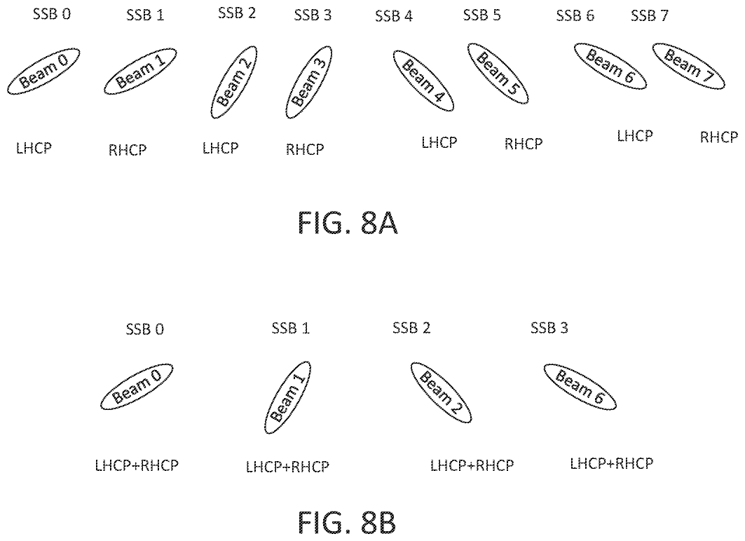

One consideration for the design of polarization SSB for NR NTN is to transmit different polarization (e.g., RHCP, LHCP) in a TDM manner. In other words, different polarization may be transmitted into different SSB. For example, Q (e.g., Q=8) SSBs may be transmitted in a NR NTN system in an initial BWP (e.g., BWP #0). Different SSB may be used with different or same spatial filter/beam, and each SSB is only associated with a single polarization e.g., LHCP or RHCP as shown in FIG. 8A. In this scenario, if UE 201 is with LHCP, RHCP. linear (single or double linear), or both LHCP and RCHP antenna pattern, then the UE 201 may detect an SSB without any ambiguity.

Another possible consideration for the design of polarization SSB for NR NTN is simultaneously transmitting different polarization (e.g., RHCP+LHCP) or any form of combination of LHCP and RHCP, e.g., LHCP−RHCP, −LHCP+RHCP, etc.) at a same SSB, e.g., polarization division multiplexing (PDM), as shown in FIG. 8B. In this method, two orthogonal polarizations may be incorporated in an SSB. Therefore, the number of SSB may only be based on the number of supported beams thus it may save SSB overhead more than TDM. If a UE 201 is with LHCP, RHCP, linear (single or double linear), or both LHCP and RCHP, the UE 201 may detect an SSB with PDM. In addition, if a UE 201 is capable of simultaneously receiving two polarizations, then the UE 201 may further combine them to enhance the detection performance.

NR SSB may be mapped to one or multiple PRACH occasions. The mapping may be configured via ssh-perRACH-OccasionAndCB-PreamblesPerSSB information element (IE) defined in NR specification. In this principal (e.g., the mapping between SSB/SSB ID and PRACH transmission occasion), UE 201 may use the same spatial information with the indicated polarization information to transmit PRACH at the corresponding PRACH occasion. In NR Rel-17, it has been agreed that polarization information may be broadcast in the system information block (SIB). Therefore, UE 201 detcest polarized SSB with the matched polarization and UE 201 may confirm the polarization scheme via the explicit polarization indication and the relevant system information from SIB. If different antenna polarization is applied to different (spot-) beam layout as shown in FIG. 7B, then having UE 201 report the capability of supporting polarization scheme may not be critical because only a single polarization may be associated with a beam. Therefore, as disclosed herein, the UE 201 may report its polarization capability to the network at least when NR NTN support two circular polarizations with a same (spot-) beam layout as shown in FIG. 7A. This reporting (i.e., polarization pattem supported in UE 201) may be done when UE 201 report its capability. If the NTN network supports two polarizations with a same beam layout (Note: SSBs may or may not be multiplexed with PDM. Different UE-specific transmission within the same beam/time may be PDMed in NR NTN.), then this information may be broadcast in SIB, e.g., ServingCellConfigCommon IE or other IEs for a service cell. For PDM, SIB may broadcast the SSB polarization with options, such as the followingRHCP, LHCP, or RHCP+LHCP. UE 201 may transmit PRACH with one of the detected polarizations or both. For instance, if a UE 201 is only capable to transmit and receive with RHCP then this UE 201 is still able to detect any SSB without interfering by the same SSB with LHCP. However, due to the limitation of this UE 201 is only capable to transmit/receive RHCP, hence, UE 201 may transmit the corresponding PRACH (e.g., the mapped SSB) with the same received spatial information and the detected polarization e.g., RHCP for this example. If a UE 201 is capable to transmit both RHCP and LHCP then UE201 may transmit the corresponding PRACH with both polarizations and the network may know UE's capability and enhanced the detection performance. In addition, the network may know UE's polarization capability thus the UE 201 reporting for polarization may not be needed for PDM.

### Polarization Indication for CSI-RS in NR NTN

In NR, the RS QCL information may be associated to an SSB/SSB ID or non-zero power (NZP) CSI-RS/CSI-RS ID. In NR NTN, QCL information (QCL-info IE) for RS needs to be extended to include the antenna circular polarization information. One consideration is adding a new parameter (e.g., polarization) in NZP-CSI-RS-Resource information elemen (IE) shown as follows:

-- ASN1START
TAG-NZP-CSI-RS-RESOURCE-START

| | |
|---|---|
| NZP-CSI-RS-Resource ::= | SEQUENCE { |
| nzp-CSI-RS-ResourceId | NZP-CSI-RS-ResourceId, |
| resourceMapping | CSI-RS-ResourceMapping, |
| powerControlOffset | INTEGER (−8..15), |
| powerControlOffsetSS | ENUMERATED{db−3, db0, db3, |
| | db6} OPTIONAL, -- |

Need R

| | |
|---|---|
| scramblingID | ScramblingId, |
| periodicityAndOffset | CSI-ResourcePeriodicityAndOffset |
| | OPTIONAL, -- Cond |

PeriodicOrSemiPersistent

| | |
|---|---|
| qcl-InfoPeriodicCSI-RS | TCI-StateId OPTIONAL, -- Cond |
| | Periodic |
| polarization | INTEGER (0, 1, 2, 3) OPTIONAL, |

...
}
-- TAG-NZP-CSI-RS-RESOURCE-STOP
-- ASN1STOP

For example, the parameter for polarization in NZP-CSI-RS-Resource may be defined as {0=None, 1=RHCP, 2=LHCP, 3=RHCP+LHCP}.

In NR NTN, the polarization indication for reference signal QCL-info may not be necessary. For example, if same beam layout for some BWPs (e.g., BWP #0 and BWP #X) as shown in FIG. 3A, then the network may configure the QCL information for reference signals (e.g., DMRS for PDCCH/PDSCH) in referenceSignal IE to SSB ID. In this case, there is no need to indicate the polarization for reference signal because the polarization indication for each SSB is broadcast in SIB, and UE 201 may refer the polarization indication of the referenceSignal in QCL-info from the SSB polarization indication in SIB. Hence, the QCL signalling overhead may be reduced for the configuration of the reference signal (e.g., PDSCH configuration BWP) for BWP(s)/CC(s). Although, the support of dynamic polarization configuration of (spot-) beams may be unlikely in NR NTN, if CSI-RS QCL information is referred from SSB/SSB ID then network only change the polarization configuration of SSB and inform UE 201 there is a SIB update. Thus, in this case, there is no need for extra polarization indication for each CSI-RS resource (e.g., add or modify NZP-CSI-RS-Resource list for each BWP or CC as NR specification) and the signaling overhead may be reduced when UE 201 enter RRC connected state.

Another method for reducing signalling overhead for RS polarization indication is the network may indicate the polarization for some or a pool of CSI-RS resources or CSI-RS resource in CSI-RS resource set through RRC signaling or be broadcast in SIB. This pool of CSI-RS resource or CSI-RS resource in CSI-RS resource set may be common in all BWPs/CCs or some configured BWPs/CCs. This may be because the multi-beam with hierarchal beam layout or same beam layout in an NTN serving cell is fixed and this (common) information may be known early for UE 201 while camping on an NTN serving cell. For example, this information (e.g. , CSI-RS resource or CSI-RS resources in CSI-RS resource set) including polarization indication may be configured in ServingCellConfig IE or shared with those CSI-RS resources configured in CSI-MeasConfig IE. When UE 201 is entered RRC connected state, the polarization indication and the QCL information for RS may be referred from this pool of CSI-RS or SSB broadcast from SIB for (all or some) BWP configuration. Through this common QCL information with polarization indication, it may facilitate TCI state update and activation for UE-dedicated PDCCH/PDSCH or UL TX spatial filter(s) for UE-dedicated PUSCH/PUCCH across a set of (configured) BWPs or CCs. For example, if the bwp-Id (e.g., the DL BWP which the RS is in) for QCL-Type (e.g., A/D) of the source RS in a QCL-Info of the TCI state is absent, then UE 201 may assume that QCL-Type of the source RS is in the BWP/CC to which the TCI state and the corresponding indicated polarization configured in that (common) pool of CSI-RS applies. In this way, the signalling overhead may be reduced even frequent BWP and beam switching occur in NR NTN. Note: RRC-configured TCI state pool(s) with the corresponding indicated polarization still may be configured in the PDSCH configuration (PDSCH-Config) for each BWP/CC as in Rel-15/16. Furthermore, if the support of dynamic polarization configuration of beams is considered in NR NTN, the network still may update or modify the polarization indication for NZP-CSI-RS resources or NZP-CSI-RS resources in an NZP-CSI-RS resource set where may be commonly referred by all or some BWPs/CCs.

If PDM (e.g., RHCP and LHCP simultaneously transmit in a same frequency domain resources) is support for some TCI state configured in PDCCH/PDSCH configuration (PDSCH-Config) for a CORESET in a BWP/CC, then UE 201 may assume the same content of PDCCH/PDSCH with two polarizations (e.g., RHCP and LHCP) are transmitted and UE 201 may perform (soft) combing of two polarizations for PDCCH/PDSCH reception to further enhance the detection performance. If a TCI state with two polarizations is support for UE-dedicated PUSCH/PUCCH, UE 201 may transmit PUCCH/PUSCH using one of the polarizations (e.g., RHCP or LHCP) with closing the other polarization transmission for power saving, or simultaneously transmit two polarizations with the same content of PUCCH/PUSCH.

A UE 201 may deduce various parameters for a (target) RS from another (source) RS, based on the network's configuration, activation and/or indication of a TCI state for the target RS, with the TCI state configuration comprising the source RS identity, QCL type, etc. For example, a UE 201 may determine Doppler shift, Doppler spread, average delay.or delay spread (QCL type A) of the target RS from the corresponding parameter value estimated from the source RS. In some cases, one or more QCL types (e.g. type A, B, C, or D) are extended to include a polarization parameter. For example, if a target CSI-RS is QCL-typeC with an SSB, the UE 201 may determine a polarization parameter of the CSI-RS from the SSB. The SSB polarization may be obtained from RRC configuration (e.g. SI) or estimation. In some cases, the network may configure which, if any, one or more QCL types that are extended with the polarization parameter.

In some cases, QCL types may be amended with a polarization parameter if polarization is configured or indicated for the SSBs of the cell.

In some cases, the IE TCI-State may be optionally expanded with a parameter to indicate that a polarization parameter may be derived from the RS(s) configured in one or both QCL-Info parameters.

In some cases, with two QCL-Info, the polarization parameter may be derived from the source RS configured for QCL-typeD. In other cases, with two QCL-Info. the polarization parameter may be derived from the source RS not configured for QCL-typeD. In yet other cases with two QCL-Info, the polarization parameter may be derived from the source RS that is an SSB. In some cases, the polarization parameter may indicate that the target RS uses the same polarization as the source RS. In some cases, the polarization parameter may indicate that the target RS uses a subset of the polarizations used for the source RS.

In some cases, the parameter QCL-Info may be optionally expanded with a parameter to indicate that a polarization parameter may be derived from the RS configured in the QCL-Info. In some cases, with two QCL-Info in a TCI state, the UE 201 may expect that only one QCL-Info is configured with a parameter for polarization QCL.

In some cases, with two QCL-Info, the UE 201 may derive polarization parameter from both source RSs. The UE 201 may in some cases expect that both source RSs use the same polarization, e.g., by having the same SSB at the end of the polarization QCL chain.

### UE Assist Beam or Joint Beam and BWP Switching in NR NTN

In NR NTN, (spot-) beam switching may frequently occur for earth fixed or earth moving cells. If the TCI-state/beam information are broadcast in the SIB or UE specific RRC configuration as proposed above, then the UE 201 may be able to predict the timing for beam switching or joint beam and BWP switching. If UE 201 may assist beam or joint beam and BWP switching, then UE 201 may save CSI-RS measurement time and CSI reporting. hence, more power saving may be achieved for UE 201. In legacy NR. TCI state may have only indicated the spatial information with other CSI-RS or SSB spatial information. However, UE 201 may not be able to assist beam or joint beam and BWP switching only based on the spatial information. As disclosed herein, if the UE 201 knows other (spot-) beam related side information like the radius of beam, elevation, satellite coordinate, or azimuth angles, etc. then the UE 201 may be able to calculate or predict when is the time for beam or joint beam and BWP switching. More details about how to associate beam related side information for NR SSB or CSI-RS are provided hereinafter. For purposes of discussion, the beam related side information may be categorized as two parts: the first part is the static beam related side information like (spot-) beam coverage (e.g., beam radius,), relative (spot-) beam center position with respect to satellite, etc. and the second part is the dynamic beam related side information like the satellite ephemeris information (e.g., position and velocity state vectors or on orbital elements, etc. The following methods may be described for UE 201 to assist beam switching or joint BWP and beam switching based on beam related side information.

The static beam related side information may be broadcast in SIB. The linkage between the static beam related side information and SSB or CSI-RS may be as follows: the network may broadcast the beam width/coverage for different beams. For example, beams for SSB may have its own static side information and CSI-RS may have a separate static side information or SSB or CSI-RS may share the same beam related side information. In this way. UE 201 may refer those beams related side information with the configured QCL information (e.g., SSB or CSI-RS) in TCI state. For the dynamic beam related side information like satellite position, velocity information, etc. may be (periodically) broadcast in SIB or UE-specific RRC signaling transmit via MAC CE to reduce UE switching back to default or initial BWP for reception of SIB during RRC connected state. For example, when UE 201 enters the RRC connected state, UE 201 may use both the static and dynamic beam related side information, the spatial information specified in TCI-state and UE position information (e.g., GNSS) to derive the timing for beam or joint beam and BWP switching. In addition, UE 201 may calculate the candidate beam (e.g., SSB ID or CSI-RS ID) and it may trigger the report to the network. UE 201 may trigger the beam or beam and BWP switching report as Rel-16 scheduling request (SR) for SCell BFR procedure. The recommended candidate beam or beam and BWP information may be sent on MAC CE. The other report triggering may be based on PRACH as Rel-15 BFR procedure. In legacy NR, if UE 201 is in an activated BWP where is not allocated with PRACH transmission occasion then UE 201 may switch back to the default or initial BWP for PRACH transmission. However, this kind of beam switching may not be preferred when BWP is used for FRF>1 in NR NTN. So, the PRACH transmission occasion may need to be configured for the activated BWP.

### Reference BWP in NR NTN

In NR, when the network configures a BWP, it conventionally needs to configure lots of configuration like PDCCH, PDSCH. CORESET, etc. In NR NTN. configured BWP may share a lot of common configuration information, for example, only the frequency interval (BWP location) should be changed accordingly or TCI state for RS, and most of the configurations like number of CORESET/CORESET pool, search space in PDCCH configuration (PDCCH-Config), etc. may be remaining the same. Therefore, a reference BWP for NR NTN may be beneficial because BWP switching may frequently occur and some parameters may need to be (re-) configured no matter for earth fixed or earth moving NTN systems. In other word, if a (new) BWP is configured for a UE 201 or a group of UEs 201, then this BWP configuration may not need to be (re-)configured for all parameters, instead, the missing parameters for this BWP may be referred from the reference BWP; signalling overhead may be reduced which it is a desired use case for NR NTN. For example. RRC configured TCI state pool(s) and its corresponding polarization information may be absent in the PDSCH configuration (PDSCH-Config) for each BWP and replaced with a reference to RRC configured TCI state pool(s) and the corresponding polarization information in a reference BWP. Another example is that if the PDCCH configuration is absent in a BWP (e.g., dedicated BWP) configuration (BWP-DownlinkDedicated) then it may be referred PDCCH configuration from the reference BWP. In this way, the network just needs to adjust or modify the difference between a BWP, and thus signalling overhead may be reduced for BWP (re-)configuration. The reference BWP configuration may be broadcast in SIB and UE 201 may have the common reference BWP information early. Or the reference BWP configuration may be via RRC signalling when UE 201 enter the RRC connected mode and only send the difference between the (new) activated BWP and reference BWP when UE 201 switch to a (new) activated BWP. For unpaired spectrum, the reference BWP configuration may be applied for DL and UL.

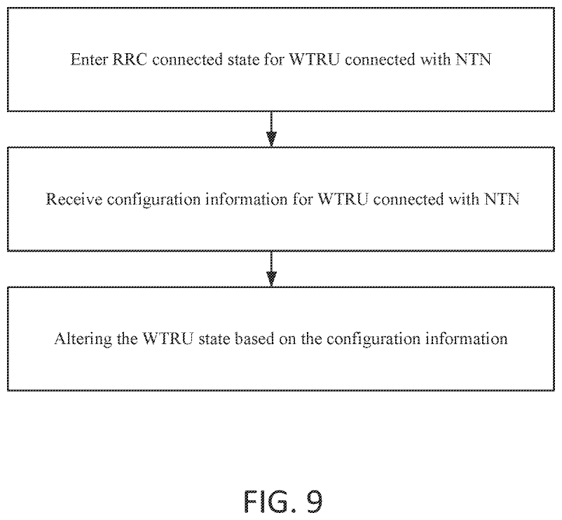

FIG. 9 illustrates an exemplary method for beam management and bandwidth part operation for NTNs. At step 221, detecting that UE 201 is an RRC connected state. UE 201 may be detect an indication (e.g., a message) that UE 201 is in RRC connected state. At step 222, subsequent to receiving the indication of being in RRC connected state (or a configuration information associated with establishing RRC connected state), receiving configuration information for a non-terrestrial connection with UE 201. The configuration information may include TCI state information, a channel state information-reference signal (CSI-RS) resource set configuration, or a bandwidth part (BWP) configuration. As disclosed herein the configuration information may be altered based on the situation to assist with beam management. At step 223, performing, by UE 201 (or base station 202), an action based on the configuration information of step 222. For example, performing handover by UE 201 in a predetermined (e.g., precalculated) period based on ephemeris data, or the like.

Table 1 is a list of acronyms that may appear in the following description. Unless otherwise specified, the acronyms used herein refer to the corresponding terms listed in Table 1.

TABLE 1

| Acronym | Description |
|---|---|
| 3GPP | 3^{rd} Generation Partnership Project |
| A/N | Ack/Nack |
| AL | Aggregation Level |
| AS | Access Stratum |
| BCCH | Broadcast Control Channel |
| BCH | Broadcast Channel |
| BD | Blind Decoding |
| BFD | Beam Failure Detection |
| BWP | BandWidth Part |
| CC | Component Carrier |
| CE | Control Element |
| CB | Code Block |
| CBG | Code Block Group |
| CCE | Control Channel Elements |
| CORESET | Control Resource Set |
| CP | Cyclic Prefix |
| CRI | CSI-RS Resource Indicator |
| CRC | Cyclic Redundancy Check |
| C-RNTI | Cell Radio-Network Temporary Identifier |
| CSI | Channel State Information |
| DCI | Downlink Control Information |
| DL | Downlink |
| DL-SCH | Downlink Shared Channel |
| DRX | Discontinuous Reception |
| DTX | Discontinuous Transmission |
| EMBB | Enhanced Mobile Broadband |
| FDRA | Frequency Domain Resource Assignment |
| FFS | For Further Study |
| FR1 | Frequency Range 1 |
| FR2 | Frequency Range 2 |
| FRF | Frequency Reuse Factor |
| GP | Guard Period |
| HARQ | Hybrid Automatic Repeat Request |
| HD | High Definition |
| IE | Information element |
| LBT | Listen Before Talk |
| LEO | Low Earth Orbit |
| LoS | Line of Sight |
| LTE | Long term Evolution |
| MAC | Medium Access Control |
| MCL | Maximum Coupling Loss |
| MEO | Medium Earth Orbit |
| MIMO | Multiple-Input Multiple-Output |
| MPL | Maximum Path Loss |
| M-TRP | Multiple Transmit Receive Point |
| NAS | Non-access Stratum |
| NACK | Non-ACKnowledgement |
| NR | New Radio |
| NR-DRS | NR Reference signal in Downlink (typically |
| | used for channel estimation) |
| NTN | Non-Terrestrial Network |
| RS | Reference signal |
| OFDM | Orthogonal frequency division multiplexing |
| PDCCH | Physical Downlink Control Channel |
| PDSCH | Physical Downlink Shared Data Channel |
| PDU | Protocol Data Unit |
| PUSCH | Physical Uplink Shared Channel |
| PRACH | Physical Random Access Channel |
| PRB | Physical Resource Block |
| QCL | Quasi-CoLocation |
| RAN | Radio Access Network |
| RAT | Radio Access Technology |
| RB | Resource block |
| RE | Resource Element |
| RI | Rank Indicator |
| RIV | Resource Indication Value |
| RNTI | Radio Network Temporary Identifier |
| RRC | Radio Resource Control |
| RTT | Round Trip Time |
| SFN | Single Frequency Network |
| SI | System Information |
| SIB | System Information Block |
| SI-RNTI | System Information RNTI |
| SLIV | Start and Length Indicator Value |
| SPS-RNTI | Semi persistent scheduling RNTI |
| SR | Scheduling Request |
| SRI | SRS Resource Indicator |
| SRS | Sounding Reference Signal |
| SS | Search Space |
| SSB | Synchronization Signal/PBCH block (SSB) |
| TA | Timing Advance |
| TAC | Timing Adjustment Command (TAC) |
| TBS | Transport Block Size |
| TB | Transport Block |
| TCI | Transmission configuration indication |
| TDD | Time Division Duplex |
| TDRA | Time Domain Resource Assignment |
| TRP | Transmission and Reception Point |
| TRS | Tracking Reference Signal |
| UE | User Equipment |
| UCI | Uplink Control Information |
| UL | Uplink |
| UR/LL | Ultra Reliable - Low Latency |
| URLLC | Ultra-Reliable and Low Latency |
| | Communications |

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 6 GHz, and it is expected to include different operating modes that may be multiplexed together in the same spectrum to address a broad set of 3GPP NR use cases with diverging requirements. The ultra-mobile broadband is expected to include cm Wave and mm Wave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mm Wave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), Non-Terrestrial Networks (NTN), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office. first responder connectivity, automotive ecall, disaster alerts, real-time gaming, multi-person video calls, autonomous driving, augmented reality, tactile intemet, virtual reality, home automation, robotics, and aerial drones to name a few. All of these use cases and others are contemplated herein.

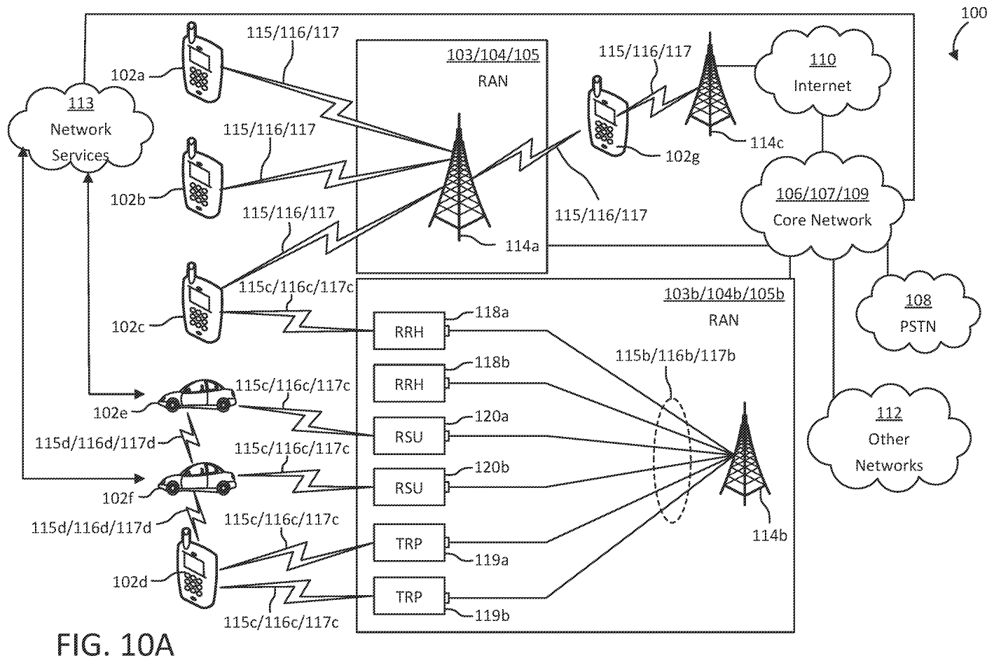

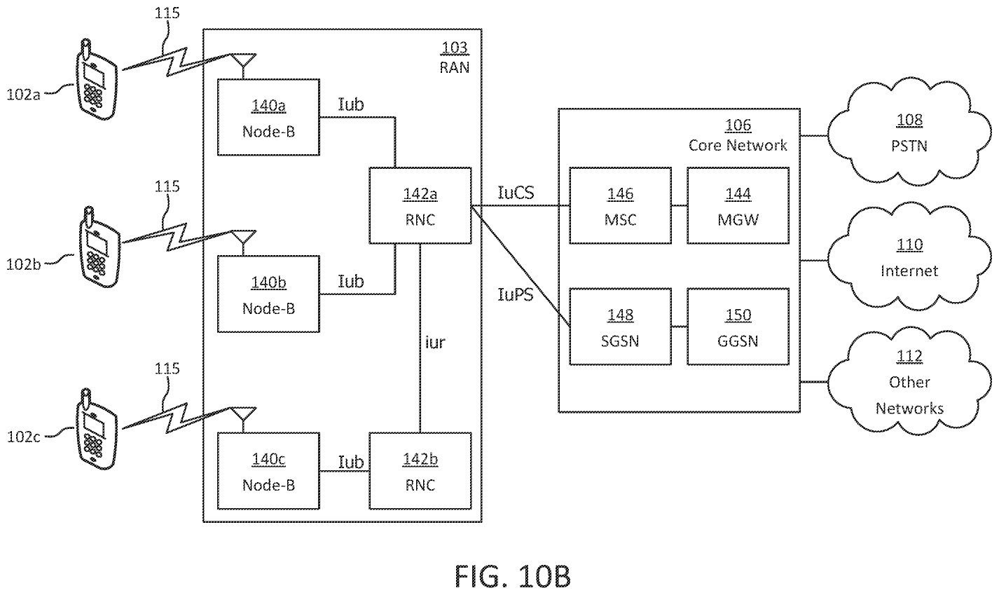

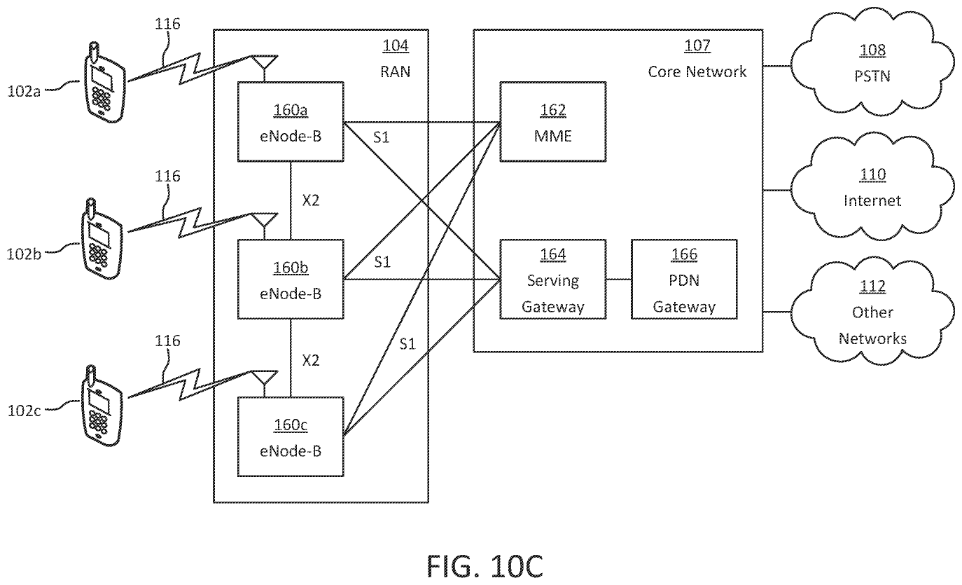

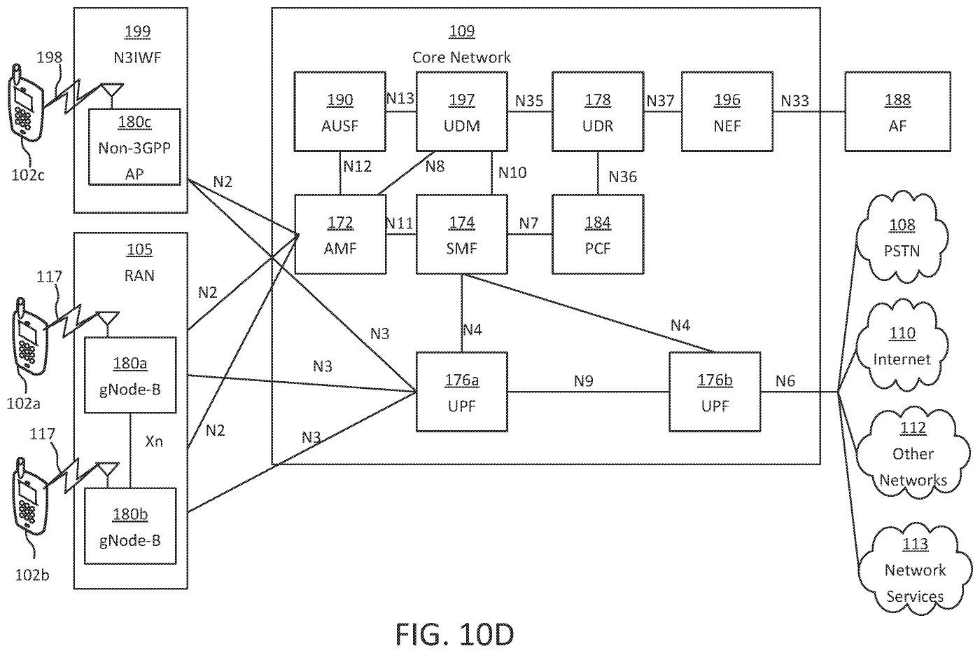

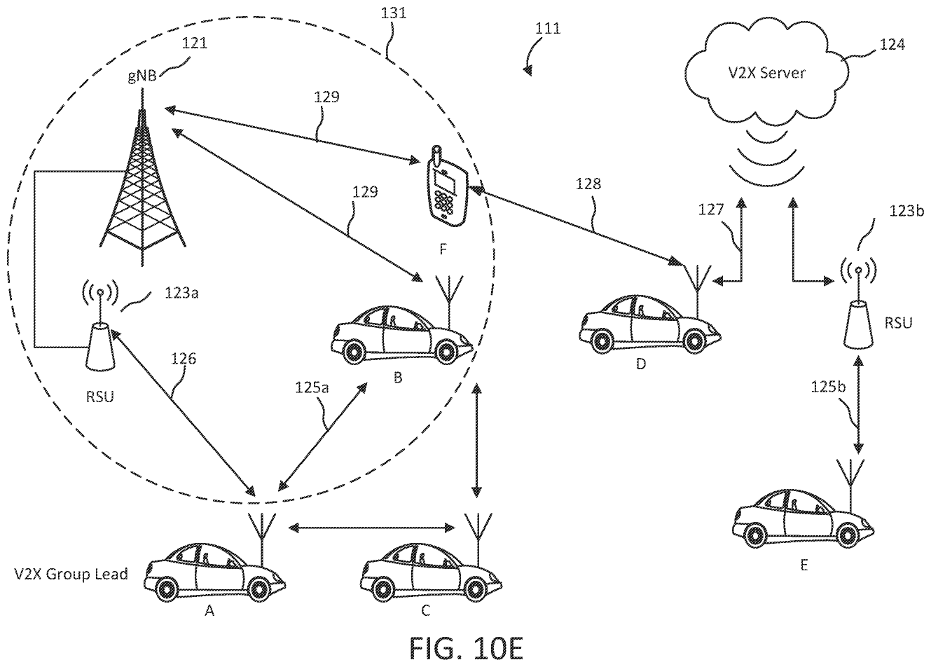

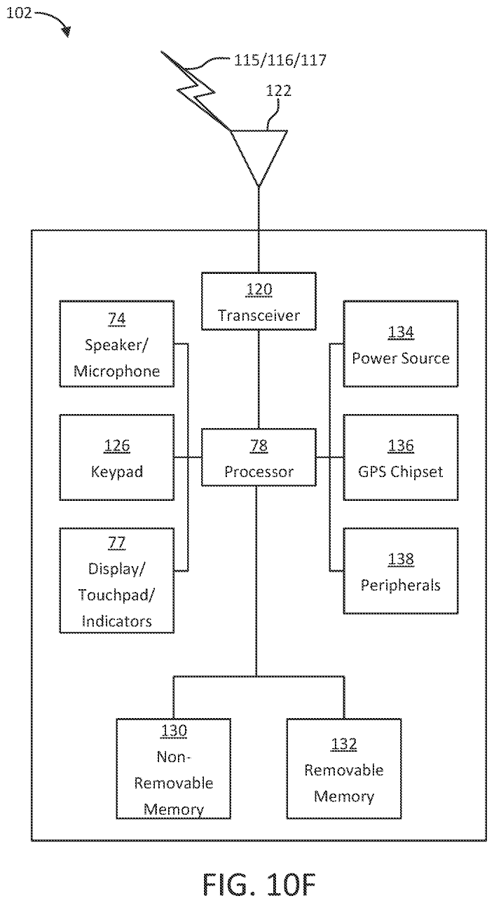

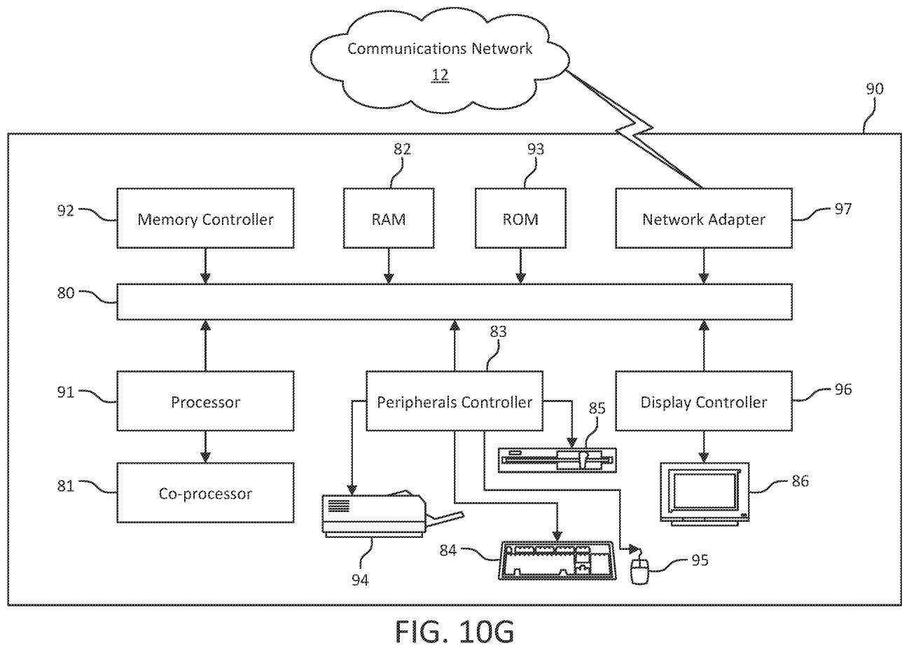

FIG. 10A illustrates an example communications system 100 in which the methods and apparatuses of beam management and bandwidth part operation for NTNs, such as the systems and methods illustrated in FIG. 4 through FIG. 9 described and claimed herein may be used. The communications system 100 may include wireless transmit/receive units (WTRUs) 102a, 102b, 102c, 102d, 102e, 102f, or 102g (which generally or collectively may be referred to as WTRU 102 or WTRUs 102). The communications system 100 may include, a radio access network (RAN) 103/104/105/103b/104b/105b, a core network 106/107/109, a public switched telephone network (PSTN) 108. the Internet 110. other networks 112. and Network Services 113. Network Services 113 may include, for example, a V2X server, V2X functions, a ProSe server, ProSe functions, IoT services, video streaming, or edge computing, etc.

It will be appreciated that the concepts disclosed herein may be used with any number of WTRUs, base stations, networks, or network elements. Each of the WTRUs 102a, 102b, 102c, 102d, 102e, 102f, or 102g may be any type of apparatus or device configured to operate or communicate in a wireless environment. Although each WTRU 102,. 102b, 102c, 102d, 102e, 102f, or 102g may be depicted in FIG. 10A, FIG. 10B, FIG. 10C. FIG. 10D, FIG. 10E, or FIG. 10F as a hand-held wireless communications apparatus, it is understood that with the wide variety of use cases contemplated for 5G wireless communications, each WTRU may comprise or be embodied in any type of apparatus or device configured to transmit or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus, truck, train, or airplane, and the like.

The communications system 100 may also include a base station 114a and a base station 114b. In the example of FIG. 10A, each base stations 114a and 114b is depicted as a single element. In practice, the base stations 114a and 114b may include any number of interconnected base stations or network elements. Base stations 114a may be any type of device configured to wirelessly interface with at least one of the WTRUs 102a, 102b, and 102c to facilitate access to one or more communication networks, such as the core network 106/107/109, the Internet 110. Network Services 113, or the other networks 112. Similarly, base station 114b may be any type of device configured to wiredly or wirelessly interface with at least one of the Remote Radio Heads (RRHs) 118a, 118b, Transmission and Reception Points (TRPs) 119a, 119b, or Roadside Units (RSUs) 120a and 120b to facilitate access to one or more communication networks, such as the core network 106/107/109. the Internet 110, other networks 112, or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110. Network Services 113, or other networks 112

TRPs 119a, 119b may be any type of device configured to wirelessly interface with at least one of the WTRU 102d, to facilitate access to one or more communication networks, such as the core network 106/107/109. the Internet 110. Network Services 113, or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations or network elements (not shown), such as a Base Station Controller (BSC), a Radio Network Controller (RNC), relay nodes, etc. Similarly, the base station 114b may be part of the RAN 103b/104b/105b, which may also include other base stations or network elements (not shown), such as a BSC, a RNC, relay nodes, etc. The base station 114a may be configured to transmit or receive wireless signals within a particular geographic region, which may be referred to as a cell (not shown). Similarly, the base station 114b may be configured to transmit or receive wired or wireless signals within a particular geographic region, which may be referred to as a cell (not shown) for methods, systems, and devices of beam management and bandwidth part operation for NTNs, as disclosed herein. Similarly, the base station 114b may be configured to transmit or receive wired or wireless signals within a particular geographic region, which may be referred to as a cell (not shown). The cell may further be divided into cell sectors. For example, the cell associated with the base station 114a may be divided into three sectors. Thus, in an example, the base station 114a may include three transceivers, e.g., one for each sector of the cell. In an example, the base station 114a may employ multiple-input multiple output (MIMO) technology and, therefore, may utilize multiple transceivers for each sector of the cell.

The base stations 114a may communicate with one or more of the WTRUs 102a, 102b, 102c, or 102g over an air interface 115/116/117, which may be any suitable wireless communication link (e.g., radio frequency (RF), microwave, infrared (IR), ultraviolet (UV), visible light, cm Wave, mm Wave, etc.). The air interface 115/116/117 may be established using any suitable radio access technology (RAT).

The base stations 114b may communicate with one or more of the RRHs 118a, 118b, TRPs 119a, 119b, or RSUs 120a, 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cm Wave, mmWave, etc.). The air interface 115b/116b/117b may be established using any suitable radio access technology (RAT).

The RRHs 118a, 118b, TRPs 119a, 119b or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cm Wave, mm Wave, etc.). The air interface 115c/116c/117c may be established using any suitable radio access technology (RAT).

The WTRUs 102a, 102b, 102c, 102d, 102e, or 102f may communicate with one another over an air interface 115d/116d/117d, such as Sidelink communication, which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) or Evolved HSPA (HSPA+). HSPA may include High-Speed Downlink Packet Access (HSDPA) or High-Speed Uplink Packet Access (HSUPA).

In an example, the base station 114a and the WTRUs 102a, 102b, 102c, or RRHs 118a, 118b, TRPs 119a, 119b, or RSUs 120a, 120b in the RAN 1036/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) or LTE-Advanced (LTE-A). In the future, the air interface 115/116/117 or 115c/116c/117c may implement 3GPP NR technology. The LTE and LTE-A technology may include LTE D2D and V2X technologies and interfaces (such as Sidelink communications, etc.). Similarly, the 3GPP NR technology includes NR V2X technologies and interface (such as Sidelink communications, etc.).

The base station 114a in the RAN 103/104/105 and the WTRUs 102a, 102b, 102c, and 102g or RRHs 118a, 118b, TRPs 119a, 119b or RSUs 120a, 120b in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 10A may be a wireless router. Home Node B. Home eNode B, or access point, for example, and may utilize any suitable RAT for facilitating wireless connectivity in a localized area, such as a place of business, a home, a vehicle, a train, an aerial, a satellite, a manufactory, a campus, and the like, for implementing the methods, systems, and devices of beam management and bandwidth part operation for NTNs, as disclosed herein. In an example, the base station 114c and the WTRUs 102, e.g., WTRU 102e, may implement a radio technology such as IEEE 802.11 to establish a wireless local area network (WLAN), similarly, the base station 114c and the WTRUs 102d, may implement a radio technology such as IEEE 802.15 to establish a wireless personal area network (WPAN). In yet another example, the base station 114c and the WTRUs 102, e.g., WTRU 102e, may utilize a cellular-based RAT (e.g., WCDMA, CDMA2000, GSM, LTE, LTE-A, NR. etc.) to establish a picocell or femtocell. As shown in FIG. 10A, the base station 114c may have a direct connection to the Internet 110. Thus, the base station 114c may not be required to access the Internet 110 via the core network 106/107/109.

The RAN 103/104/105 or RAN 103b/104b/105b may be in communication with the core network 106/107/109, which may be any type of network configured to provide voice, data, messaging, authorization and authentication, applications, or voice over internet protocol (VOIP) services to one or more of the WTRUs 102a, 102b, 102c, 102d. For example, the core network 106/107/109 may provide call control, billing services, mobile location-based services, pre-paid calling, Internet connectivity, packet data network connectivity, Ethemet connectivity, video distribution, etc., or perform high-level security functions, such as user authentication.

Although not shown in FIG. 10A, it will be appreciated that the RAN 103/104/105 or RAN 103b/104b/105b or the core network 106/107/109 may be in direct or indirect communication with other RANs that employ the same RAT as the RAN 103/104/105 or RAN 103b/104b/105b or a different RAT. For example, in addition to being connected to the RAN 103/104/105 or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102a, 102b, 102c, 102d, 102e to access the PSTN 108, the Internet 110, or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned or operated by other service providers. For example, the networks 112 may include any type of packet data network (e.g., an IEEE 802.3 Ethernet network) or another core network connected to one or more RANs, which may employ the same RAT as the RAN 103/104/105 or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links for implementing methods, systems, and devices of beam management and bandwidth part operation for NTNs, as disclosed hercin. For example, the WTRU 102g shown in FIG. 10A may be configured to communicate with the base station 114a, which may employ a cellular-based radio technology, and with the base station 114c, which may employ an IEEE 802 radio technology.

Although not shown in FIG. 10A. it will be appreciated that a User Equipment may make a wired connection to a gateway. The gateway maybe a Residential Gateway (RG). The RG may provide connectivity to a Core Network 106/107/109. It will be appreciated that much of the subject matter included herein may equally apply to UEs that are WTRUs and UEs that use a wired connection to connect with a network. For example, the subject matter that applies to the wireless interfaces 115, 116, 117 and 115c/116c/117c may equally apply to a wired connection.

FIG. 10B is a system diagram of an example RAN 103 and core network 106 that may implement methods, systems, and devices of beam management and bandwidth part operation for NTNs, as disclosed herein. As noted above, the RAN 103 may employ a UTRA radio technology to communicate with the WTRUs 102a, 102b, and 102c over the air interface 115. The RAN 103 may also be in communication with the core network 106. As shown in FIG. 10B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 10B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an lub interface. The RNCs 142a and 142b may be in communication with one another via an lur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 10B may include a media gateway (MGW) 144, a Mobile Switching Center (MSC) 146, a Serving GPRS Support Node (SGSN) 148, or a Gateway GPRS Support Node (GGSN) 150. While each of the foregoing elements are depicted as part of the core network 106, it will be appreciated that any one of these elements may be owned or operated by an entity other than the core network operator.

The RNC 142a in the RAN 103 may be connected to the MSC 146 in the core network 106 via an luCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112. which may include other wired or wireless networks that are owned or operated by other service providers.

FIG. 10C is a system diagram of an example RAN 104 and core network 107 that may implement methods, systems, and devices of beam management and bandwidth part operation for NTNs, as disclosed herein. As noted above. the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example. may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink or downlink, and the like. As shown in FIG. 10C. the eNode-Bs 160a, 160b, and 160c may communicate with one another over an X2 interface.

The core network 107 shown in FIG. 10C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned or operated by an entity other than the core network operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the SI interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices.

For example, the core network 107 may include, or may communicate with. an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned or operated by other service providers.

FIG. 10D is a system diagram of an example RAN 105 and core network 109 that may implement methods, systems, and devices of beam management and bandwidth part operation for NTNs, as disclosed herein. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink or downlink, and the like. As shown in FIG. 10D, the gNode-Bs 180a and 180b may communicate with one another over an Xn interface, for example.

The core network 109 shown in FIG. 10D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless or network communications or a computer system, such as system 90 illustrated in FIG. 10G.

In the example of FIG. 10D, the 5G Core Network 109 may include an access and mobility management function (AMF) 172, a Session Management Function (SMF) 174. User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned or operated by an entity other than the core network operator. It will also be appreciated that a 5G core network may not consist of all of these elements, may consist of additional clements, and may consist of multiple instances of each of these elements. FIG. 10D shows that network functions directly connect with one another, however, it should be appreciated that they may communicate via routing agents such as a diameter routing agent or message buses.

In the example of FIG. 10D, connectivity between network functions is achieved via a set of interfaces, or reference points. It will be appreciated that network functions may be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an NII interface. The AMF 172 may generally route and forward NAS packets to/from the WTRUs 102a, 102b, and 102c via an N1 interface. The NI interface is not shown in FIG. 10D.

The SMF 174 may be connected to the AMF 172 via an N11 interface. Similarly the SMF may be connected to the PCF 184 via an N7 interface, and to the UPFs 176a and 176b via an N4 interface. The SMF 174 may serve as a control node. For example, the SMF 174 may be responsible for Session Management. IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a. 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 10D. The PCF 184 may provide policy rules to control plane nodes such as the AMF 172 and SMF 174, allowing the control plane nodes to enforce these rules. The PCF 184. may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect with network functions, so that network function can add to, read from, and modify the data that is in the repository. For example, the UDR 178 may connect with the PCF 184 via an N36 interface. Similarly, the UDR 178 may connect with the NEF 196 via an N37 interface, and the UDR 178 may connect with the UDM 197 via an N35 interface.

The UDM 197 may serve as an interface between the UDR 178 and other network functions. The UDM 197 may authorize network functions to access of the UDR 178. For example, the UDM 197 may connect with the AMF 172 via an N8 interface, the UDM 197 may connect with the SMF 174 via an N10 interface. Similarly, the UDM 197 may connect with the AUSF 190 via an N13 interface. The UDR 178 and UDM 197 may be tightly integrated.

The AUSF 190 performs authentication related operations and connect with the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect with an AF 188 via an N33 interface and it may connect with other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g. in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 10D, in a network slicing scenario, a WTRU 102a, 102b, or 102c may connect with an AMF 172, via an NI interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned or operated by other service providers.

The core network entities described herein and illustrated in FIG. 10A, FIG. 10C, FIG. 10D, or FIG. 10E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIG. 10A, FIG. 10B, FIG. 10C, FIG. 10D, or FIG. 10E are provided by way of example only, and it is understood that the subject matter disclosed and claimed herein may be embodied or implemented in any similar communication system, whether presently defined or defined in the future.

FIG. 10E illustrates an example communications system 111 in which the systems, methods, apparatuses that implement beam management and bandwidth part operation for NTNs, described herein, may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, or other network elements. One or several or all WTRUs A, B, C, D, E, and F may be out of range of the access network coverage 131. WTRUs A, B, and C form a V2X group, among which WTRU A is the group lead and WTRUs B and Care group members.

WTRUS A, B, C, D, E, and F may communicate with each other over a Uu interface 129 via the gNB 121 if they are within the access network coverage 131. In the example of FIG. 10E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 10E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127, WTRUs A, B, C, D, E, and F may communicate to another UE via a Vehicle-to-Person (V2P) interface 128.

FIG. 10F is a block diagram of an example apparatus or device WTRU 102 that may be configured for wireless communications and operations in accordance with the systems, methods, and apparatuses that implement beam management and bandwidth part operation for NTNs, described herein, such as a WTRU 102 of FIG. 10A, FIG. 10B, FIG. 10C, FIG. 10D, or FIG. 10E, or FIG. 4-FIG. 7. As shown in FIG. 10F, the example WTRU 102 may include a processor 78, a transceiver 120, a transmit/receive element 122, a speaker/microphone 74, a keypad 126, a display/touchpad/indicators 77, non-removable memory 130, removable memory 132, a power source 134, a global positioning system (GPS) chipset 136, and other peripherals 138. It will be appreciated that the WTRU 102 may include any sub-combination of the foregoing clements. Also, the base stations 114a and 114b, or the nodes that base stations 114a and 114b may represent, such as but not limited to transceiver station (BTS), a Node-B, a site controller, an access point (AP), a home node-B, an evolved home node-B (cNodeB), a home evolved node-B (HeNB), a home evolved node-B gateway, a next generation node-B (gNode-B), and proxy nodes, among others, may include some or all of the elements depicted in FIG. 10F and may be an exemplary implementation that performs the disclosed systems and methods for beam management and bandwidth part operation for NTNs described herein.

The processor 78 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs). Field Programmable Gate Array (FPGAs) circuits, any other type of integrated circuit (IC), a state machine, and the like. The processor 78 may perform signal coding, data processing, power control, input/output processing, or any other functionality that enables the WTRU 102 to operate in a wireless environment. The processor 78 may be coupled to the transceiver 120, which may be coupled to the transmit/receive element 122. While FIG. 10F depicts the processor 78 and the transceiver 120 as separate components, it will be appreciated that the processor 78 and the transceiver 120 may be integrated together in an electronic package or chip.

The transmit/receive element 122 of a UE may be configured to transmit signals to, or receive signals from, a base station (e.g., the base station 114a of FIG. 10A) over the air interface 115/116/117 or another UE over the air interface 115d/116d/117d. For example, the transmit/receive element 122 may be an antenna configured to transmit or receive RF signals. The transmit/receive element 122 may be an emitter/detector configured to transmit or receive IR, UV, Radar, LIDAR, or visible light signals, for example. The transmit/receive element 122 may be configured to transmit and receive both RF and light signals. It will be appreciated that the transmit/receive element 122 may be configured to transmit or receive any combination of wireless or wired signals.

In addition, although the transmit/receive element 122 is depicted in FIG. 10F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs. RSUs, or nodes.

The processor 78 of the WTRU 102 may be coupled to, and may receive user input data from, the speaker/microphone 74, the keypad 126, or the display/touchpad/indicators 77 (e.g., a liquid crystal display (LCD) display unit or organic light-emitting diode (OLED) display unit. The processor 78 may also output user data to the speaker/microphone 74, the keypad 126, or the display/touchpad/indicators 77. In addition, the processor 78 may access information from, and store data in, any type of suitable memory, such as the non-removable memory 130 or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 78 may access information from, and store data in, memory that is not physically located on the WTRU 102, such as on a server that is hosted in the cloud or in an edge computing platform or in a home computer (not shown).

The processor 78 may be configured to control lighting patterns, images, or colors on the display or indicators 77 in response to whether the setup of the beam management and bandwidth part operation for NTNs in some of the examples described herein are successful or unsuccessful, or otherwise indicate a status of beam management and bandwidth part operation for NTNs and associated components. The control lighting patterns, images, or colors on the display or indicators 77 may be reflective of the status of any of the method flows or components in the FIG.'s illustrated or discussed herein (e.g., FIG. 4-FIG. 9, etc). Disclosed herein are messages and procedures of beam management and bandwidth part operation for NTNs. The messages and procedures may be extended to provide interface/API for users to request resources via an input source (e.g., speaker/microphone 74, keypad 126, or display/touchpad/indicators 77) and request, configure, or query beam management and bandwidth part operation for NTNs related information, among other things that may be displayed on display 77.

The processor 78 may receive power from the power source 134 and may be configured to distribute or control the power to the other components in the WTRU 102. The power source 134 may be any suitable device for powering the WTRU 102. For example, the power source 134 may include one or more dry cell batteries, solar cells, fuel cells, and the like.

The processor 78 may also be coupled to the GPS chipset 136. which may be configured to provide location information (e.g., longitude and latitude) regarding the current location of the WTRU 102. In addition to, or in lieu of, the information from the GPS chipset 136. the WTRU 102 may receive location information over the air interface 115/116/117 from a base station (e.g., base stations 114a, 114b) or determine its location based on the timing of the signals being received from two or more nearby base stations. It will be appreciated that the WTRU 102 may acquire location information by way of any suitable location-determination method.

The processor 78 may further be coupled to other peripherals 138, which may include one or more software or hardware modules that provide additional features, functionality. or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth ® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect with other components, modules, or systems of such apparatuses or devices via one or more interconnect interfaces, such as an interconnect interface that may comprise one of the peripherals 138.

FIG. 10G is a block diagram of an exemplary computing system 90 in which one or more apparatuses of the communications networks illustrated in FIG. 10A, FIG. 10C, FIG. 10D and FIG. 10E as well as beam management and bandwidth part operation for NTNs, such as the systems and methods illustrated in FIG. 4 through FIG. 9 described and claimed herein may be embodied, such as certain nodes or functional entities in the RAN 103/104/105, Core Network 106/107/109, PSTN 108, Intemet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general purpose processor, a special purpose processor, a conventional processor, a digital signal processor (DSP). a plurality of microprocessors, one or more microprocessors in association with a DSP core, a controller, a microcontroller, Application Specific Integrated Circuits (ASICs). Field Programmable Gate Array (FPGAs) circuits, any other type of integrated circuit (IC), a state machine, and the like. The processor 91 may perform signal coding, data processing, power control, input/output processing, or any other functionality that enables the computing system 90 to operate in a communications network. Coprocessor 81 is an optional processor, distinct from main processor 91, that may perform additional functions or assist processor 91. Processor 91 or coprocessor 81 may receive, generate, and process data related to the methods and apparatuses disclosed herein for beam management and bandwidth part operation for NTNs.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally include stored data that cannot easily be modified. Data stored in RAM 82 may be read or changed by processor 91 or other hardware devices. Access to RAM 82 or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space: it cannot access memory within another process's virtual address space unless memory sharing between the processes has been set up.

In addition, computing system 90 may include peripherals controller 83 responsible for communicating instructions from processor 91 to peripherals, such as printer 94. keyboard 84, mouse 95, and disk drive 85.

Display 86, which is controlled by display controller 96. is used to display visual output generated by computing system 90. Such visual output may include text. graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may include communication circuitry, such as for example a wireless or wired network adapter 97, that may be used to connect computing system 90 to an external communications network or devices, such as the RAN 103/104/105, Core Network 106/107/109, PSTN 108, Intemet 110. WTRUs 102, or Other Networks 112 of FIG. 10A, FIG. 10B, FIG. 10C, FIG. 10D, or FIG. 10E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 78 or 91. cause the processor to perform or implement the systems, methods and processes described herein. Specifically, any of the steps, operations, or functions described herein may be implemented in the form of such computer executable instructions, executing on the processor of an apparatus or computing system configured for wireless or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

In describing preferred methods, systems, or apparatuses of the subject matter of the present disclosure-beam management and bandwidth part operation for NTNs -as illustrated in the Figures, specific terminology is employed for the sake of clarity. The claimed subject matter, however, is not intended to be limited to the specific terminology so selected.

The various techniques described herein may be implemented in connection with hardware, firmware, software or, where appropriate, combinations thereof. Such hardware, firmware, and software may reside in apparatuses located at various nodes of a communication network. The apparatuses may operate singly or in combination with each other to effectuate the methods described herein. As used herein, the terms “apparatus,” “network apparatus,” “node,” “device,” “network node,” or the like may be used interchangeably. In addition, the use of the word “or” is generally used inclusively unless otherwise provided herein.

This written description uses examples for the disclosed subject matter, including the best mode, and also to enable any person skilled in the art to practice the disclosed subject matter, including making and using any devices or systems and performing any incorporated methods. The disclosed subject matter may include other examples that occur to those skilled in the art (e.g , skipping steps, combining steps, or adding steps between exemplary methods disclosed herein).

Methods, systems, and apparatuses, among other things, as described herein may provide for neam management and bandwidth part operation for NTNs. NTN Beam management methods for both one beam per cell and for multiple beams per cell, and shown and described herein. Network may not need to update the TCI configuration while UE perform handover. UE can assume PDCCH and PDSCH TCI state QCL (e.g., at least Type-D) with the SSB transmitted in the cell. UE enters RRC connected mode (RRC_CONNECTED state), the network/gNB can configure the UE with a set of TCI state information including neighbor's cell TCI states. A group common DCI may be used for the indication of a group of NTN UEs. If the indicated TCI state (e.g., indicated by DCI or MAC-CE) is different than the current TCI state then UE can assume BWP switching while switching the TCI state. A group common MAC-CE can also be used for the indication of a group of NTN UEs. Here, the group common MAC-CE refers to MAC-CE multiplexed in multicast shared channel. NTN UE can perform intra-frequency measurement without switching to other BWP and the intra frequency measurement (e.g., cell selection/reselection) report may be used for beam switching. The CSI measurement may be supported outside of an activated BWP for NTN UE, i.e., in inactive BWP. The network can configure a set/sequence of TCI states and each TCI state maybe associated with an explicit time value or a timer. When TCI state is going to be expired, UE may request a TCI state switching feedback to the network. The switching request may be based on a scheduling request (SR), a configured grant (CG) or contention free PRACH for requesting a TCI state update. DL data channel (e g., PDSCH) may not be multiplexed with the CSI-RS resource associated with other TCI states. All combinations in this paragraph and the below paragraphs (including the removal or addition of steps) are contemplated in a manner that is consistent with the other portions of the detailed description.

A beam failure detection method for NR NTN as shown and described herein. Aperiodic CSI-RS (AP-CSI-RS) resource may be used for the beam candidate selection for NTN UE in beam failure detection. The SS/PBCH block may be used for beam candidate selection in beam candidate selection based on a specific BWP. For NTN UE, it may not need to use periodical CSI-RS for beam failure detection, if some TCI states are pre-configured for NTN UE. All combinations in this paragraph and the below paragraphs (including the removal or addition of steps) are contemplated in a manner that is consistent with the other portions of the detailed description.

BWP operations for NR NTN, including BWP switching via group common PDCCH (GC-PDCCH), increasing number of BWPs for NR NTN, and simultaneous TCI sates update/indication when BWP switching, as shown and described herein. The total number of BWP in NTN may be more than the regular UE. BWP may be reserved for frequency reuse. When BWP switching for NTN UE, the TCI state may be automatically updated as well. All combinations in this paragraph (including the removal or addition of steps) are contemplated in a manner that is consistent with the other portions of the detailed description.

A method, system, or apparatus provides for recognizing (e.g., receiving or detecting) an indication that a wireless transmit/receive unit (WTRU) has entered into a radio resource control (RRC) connected state: and based on entering the RRC connected state (e.g., when the WTRU is in RRC connected state), receiving configuration information from a base station, wherein the base station communicates with a non-terrestrial device (e.g., satellite). wherein the configuration information comprises transmission configuration indication (TCI) state information, or wherein the TCI state information comprises one or more TCI states for a non-serving cell configuration: and altering (or determining to not alter) the TCI state of the WTRU based on the TCI state information. A method, system, or apparatus may provide for determining the TCI state for a plurality of periods based on satellite ephemeris data and performing handover based on the TCI state for the plurality of periods. The TCI state information may be based on a non-serving synchronization signal block (SSB). The TCI state information may be based on satellite ephemeris data. The TCI state information may be based on satellite ephemeris data The TCI state information may include one or more TCI states for a non-serving source reference signal (RS). The TCI state information comprises a TCI indication for physical downlink control channel (PDCCH) or physical downlink shared data channel (PDSCH) in a group common downlink control information (DCI) format. The base station may be linked to a non-terrestrial device, such as a satellite. A method, system, or apparatus may provide for upating TCI state of the WTRU based on information associated with beam failure detection or a beam failure request. All combinations in this paragraph (including the removal or addition of steps) are contemplated in a manner that is consistent with the other portions of the detailed description.

1. A method comprising:
receiving, by a wireless transmit/receive unit (WTRU), configuration information for beam management from a base station,
wherein the configuration information comprises transmission configuration indication (TCI) state information and a bandwidth part (BWP) configuration,
wherein the TCI state information comprises one or more TCI states for a serving cell configuration or one or more TCI states for a one or more TCI states for a non-serving neighbor cell configuration, and a circular polarization indication, and
wherein the one or more TCI states are associated with a time value:
updating, based on the time value, the one or more TCI states; and
managing one or more beams of the WTRU based on the one or more updated TCI states.

2. The method of claim 1, wherein the circular polarization indication comprises left-hand circular polarization (LHCP) or right-hand circular polarization (RHCP).

3. The method of claim 1, wherein the base station is a non-terrestrial device or the base station communicates with a non-terrestrial device.

4. The method of claim 1, further comprising receiving a group common medium access control-control element (MAC-CE) for the indication of a group of non-terrestrial WTRUs that include the WTRU.

5. The method of claim 4, wherein the group common medium access control control element (MAC-CE) refers to a MAC-CE multiplexed in multicast shared channel.

6. The method of claim 1, wherein the TCI state information comprises a TCI indication for physical downlink control channel (PDCCH) or physical downlink shared data channel (PDSCH) in a group common downlink control information (DCI) format.

7. The method of claim 1, further comprising updating a TCI state of the WTRU based on an indication of beam failure detection or a beam failure request.

8. The method of claim 1, further comprising, on condition that a frequency reuse factor (FRF) is greater than 1 or and an indicated TCI state of the TCI state information is different than a current TCI state of the WTRU, performing BWP switching and TCI state update at the same time by WTRU.

9. A wireless transmit/receive unit (WTRU), the WTRU comprises:
a processor, and
memory coupled with the processor, the memory storing executable instructions that when executed by the processor cause the processor to effectuate operations comprising:
receiving configuration information for beam management from a base station,
wherein the configuration information comprises transmission configuration indication (TCI) state information and a bandwidth part (BWP) configuration, and
wherein the TCI state information comprises one or more TCI states for a serving cell configuration or one or more TCI states for a neighbor cell configuration, and a circular polarization indication, and
wherein the one or more TCI states are associated with a time value:
updating, based on the time value, the one or more TCI states; and
managing one or more beams of the WTRU based on the one or more updated TCI states.

10. The WTRU of claim 9, wherein the circular polarization indication comprises left-hand circular polarization (LHCP) or right-hand circular polarization (RHCP).

11. The WTRU of claim 9, wherein the base station is a non-terrestrial device or the base station communicates with a non-terrestrial device.

12. The WTRU of claim 9, further comprising receiving a group common medium access control-control element (MAC-CE) for the indication of a group of non-terrestrial WTRUs that include the WTRU.

13. The WTRU of claim 12, wherein the group common medium access control control element (MAC-CE) refers to a MAC-CE multiplexed in multicast shared channel.

14. The WTRU of claim 9, wherein the TCI state information comprises a TCI indication for physical downlink control channel (PDCCH) or physical downlink shared data channel (PDSCH) in a group common downlink control information (DCI) format.

15. The WTRU of claim 9, further comprising updating a TCI state of the WTRU based on an indication of beam failure detection or a beam failure request.

16. A computer readable storage medium storing computer executable instructions that when executed by a computing device cause the computing device to effectuate operations comprising:
receiving, by a wireless transmit/receive unit (WTRU), configuration information for beam management from a base station,
wherein the configuration information comprises transmission configuration indication (TCI) state information and a bandwidth part (BWP) configuration, and
wherein the TCI state information comprises one or more TCI states for a serving cell configuration or one or more TCI states for a neighbor cell configuration, and a circular polarization indication, and
wherein the one or more TCI states are associated with a time value;
updating, based on the time value, the one or more TCI states; and
managing one or more beams of the WTRU based on the one or more updated TCI states.

17. The computer readable storage medium of claim 16, wherein the circular polarization indication comprises left-hand circular polarization (LHCP) or right-hand circular polarization (RHCP).

18. The computer readable storage medium of claim 16, wherein the base station is a non-terrestrial device or the base station communicates with a non-terrestrial device.

19. The computer readable storage medium of claim 16, further comprising receiving a group common medium access control-control element (MAC-CE) for the indication of a group of non-terrestrial WTRUs that include the WTRU.

20. The computer readable storage medium of claim 16, further comprising updating a TCI state of the WTRU based on an indication of beam failure detection or a beam failure request.
